(19) United States
(12) Patent Application Publication
(10) Pub. No.: US 2026/0079423 A1
(43) Pub. Date: Mar. 19, 2026

(54) CARTRIDGE

(71) Applicant: CANON KABUSHIKI KAISHA, Tokyo (JP)

(72) Inventor: AKINORI MITSUMATA, Tokyo (JP)

(21) Appl. No.: 19/326,956

(22) Filed: Sep. 12, 2025

(30) Foreign Application Priority Data
Sep. 13, 2024 (JP) 2024-159514

(51) Int. Cl. G03G 15/08; G03G 15/01; G03G 21/16

(52) U.S. Cl. CPC G03G 15/0875; G03G 15/0121; G03G 15/0189; G03G 15/0879; G03G 15/0886; G03G 15/0891; G03G 21/1633

(57) ABSTRACT

A cartridge includes an air chamber partitioned from a developer storage chamber by a filter that allows passage of air and prevents passage of developer, and is provided with an intake port for taking in air from outside, the air chamber being aligned with the developer storage chamber in a first direction, a first cover portion configured to be movable between a closed position where a discharge port of the developer provided in the developer storage chamber is closed by the first cover portion and an open position where the discharge port is opened by the first cover portion; and a second cover portion where the intake port is closed.

### BACKGROUND

### Field of the Technology

The present disclosure relates to a cartridge that stores a developer and an image forming apparatus including the cartridge.

### Description of the Related Art

In general, an electrophotographic image forming apparatus forms an image by transferring a toner image (developer image) formed on a surface of a photosensitive drum onto a transfer material as a transfer medium. As a toner (developer) supply method, for example, a process cartridge system or a toner supply system is known. The process cartridge system is a system in which the photosensitive drum and the developer container are integrated as a process cartridge, and in which the process cartridge is replaced with a new one when the developer runs out. On the other hand, the toner supply system is a system of newly supplying toner to the developer container when the toner runs out. Conventionally, there has been proposed an image forming apparatus that supplies toner to a developer container using a toner pack detachable from the developer container (see Japanese Patent Application Publication No. 2020-154300). In addition, an image forming apparatus including a developing apparatus that stores toner, a toner container that stores toner to be supplied to the developing apparatus, and an air pump that sends air to the toner container has been proposed (see Japanese Patent Application Publication No. 2000-147884). This image forming apparatus is provided with an air filter that allows only air, among the toner and air sent from the toner container to the developing apparatus, to be vented to the outside of the developing apparatus.

### SUMMARY

The present disclosure is directed to provide an embodiment of a cartridge that stores toner and an image forming apparatus including the cartridge.

To solve the above-mentioned problems, the cartridge of the present disclosure includes the following:
a developer storage chamber that stores developer and is provided with a discharge port for discharging the stored developer to outside of the cartridge;
a filter that allows air to pass therethrough and prevents developer from passing therethrough;
an air chamber that is partitioned from the developer storage chamber by the filter and is provided with an intake port for taking in air from the outside, the air chamber being aligned with the developer storage chamber in a first direction;
a first cover portion configured to be movable between a closed position where the discharge port is closed by the first cover portion and an open position where the discharge port is opened by the first cover portion; and
a second cover portion that closes the intake port.

To solve the above-mentioned problems, the cartridge of the present disclosure includes the following:
a developer storage chamber that stores developer and is provided with a discharge port for discharging the stored developer to outside of the cartridge;
a filter that allows air to pass therethrough and prevents developer from passing therethrough;
an air chamber that is partitioned from the developer storage chamber by the filter and is provided with an intake port for taking in air from the outside, the air chamber being aligned with the developer storage chamber in a first direction; and
a first cover portion that is configured to be movable between a first closed position where the discharge port is closed and a first open position where the discharge port is opened.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic overall view illustrating an image forming apparatus according to a first embodiment.

FIG. 2A is a perspective view illustrating the image forming apparatus.

FIG. 2B is a perspective view illustrating the image forming apparatus in a state where a front door is opened.

FIG. 2C is a perspective view illustrating the image forming apparatus with the toner cartridge removed.

FIG. 3A is a perspective view illustrating an image forming unit.

FIG. 3B is a perspective view illustrating the image forming unit in a state where the toner cartridge is removed.

FIG. 4 is a perspective view illustrating an optical path of a laser beam emitted from a laser scanner.

FIG. 5A is a plan view of the laser scanner and the image forming unit.

FIG. 5B is a plan view illustrating the image forming unit.

FIG. 6A is a cross-sectional view illustrating a cross section taken along line 6A-6A of FIG. 5B.

FIG. 6B is a cross-sectional view illustrating a 6B-6B cross section of FIG. 5B.

FIG. 7 is a cross-sectional view of the laser scanner and the image forming unit.

FIG. 8 is a perspective view illustrating a state in which the image forming unit is pulled out from the apparatus main body.

FIG. 9A is a front view of a toner cartridge.

FIG. 9B is a top view of the toner cartridge.

FIG. 9C is a bottom view illustrating the toner cartridge.

FIG. 9D is a right side view of the toner cartridge.

FIG. 9E is a rear view of the toner cartridge.

FIG. 10A is a front view illustrating a cross section taken along line 10A-10A of FIG. 9B.

FIG. 10B is a perspective view illustrating a cross section taken along line 10A-10A of FIG. 9B.

FIG. 10C is an exploded front view illustrating a cross section taken along line 10A-10A of FIG. 9B.

FIG. 11 is a partially enlarged view illustrating a joint portion between the first frame and the second frame.

FIG. 12A is a diagram of a state in which an air intake port and a toner discharge port are covered with a cover in a cross-sectional view taken along line 12A-12A of FIG. 9E.

FIG. 12B is a diagram of a state in which the cover is retracted and the air intake port and the toner discharge port are exposed in a cross-sectional view taken along line 12A-12A of FIG. 9E.

FIG. 13A is a cross-sectional view of a state in which the toner cartridge is removed from a cartridge holder in a partial cross-sectional view taken along line 13A-13A in FIG. 5B.

FIG. 13B is a partial cross-sectional view taken along line 13A-13A in FIG. 5B in a state where the toner cartridge is mounted to the cartridge holder.

FIG. 14A is a perspective view of a configuration integrally including a cover for an air intake port of the toner cartridge and a cover for the toner discharge port in another embodiment.

FIG. 14B is a partial cross-sectional view of a portion corresponding to a cross section taken along line 13A-13A of FIG. 5B in another embodiment, and is a cross-sectional view in a state where the toner cartridge is removed from the cartridge holder.

FIG. 14C is a partial cross-sectional view of a portion corresponding to a cross section taken along line 13A-13A of FIG. 5B in another embodiment, and is a cross-sectional view in a state where the toner cartridge is mounted to the cartridge holder.

FIG. 15A is a partial cross-sectional view of a portion corresponding to a cross section taken along line 13A-13A of FIG. 5B in another embodiment, and is a cross-sectional view in a state where an intake port cover is mounted to the toner cartridge.

FIG. 15B is a partial cross-sectional view of a portion corresponding to a cross section taken along line 13A-13A of FIG. 5B in another embodiment, and is a cross-sectional view in a state where the intake port cover is removed from the toner cartridge.

FIG. 15C is a partial cross-sectional view of a portion corresponding to a cross section taken along line 13A-13A of FIG. 5B in another embodiment, and is a cross-sectional view in a state where the toner cartridge in a state where the intake port cover is removed is removed from the cartridge holder.

FIG. 15D is a partial cross-sectional view of a portion corresponding to a cross section taken along line 13A-13A of FIG. 5B in another embodiment, and is a cross-sectional view in a state where the toner cartridge is mounted to the cartridge holder.

FIG. 16A is a partial cross-sectional view of a portion corresponding to a cross section taken along line 13A-13A of FIG. 5B in another embodiment, and is a cross-sectional view in a state where the toner cartridge starts to be mounted to the cartridge holder.

FIG. 16B is a partial cross-sectional view of a portion corresponding to a cross section taken along line 13A-13A of FIG. 5B in another embodiment, and is a cross-sectional view in a state where the toner cartridge is completely mounted to the cartridge holder.

FIG. 16C is a partial cross-sectional view taken along line 16A-16A in FIG. 5B in another embodiment, and is a cross-sectional view in a state where the toner cartridge is completely mounted to the cartridge holder.

### DESCRIPTION OF THE EMBODIMENTS

Modes for implementing the present disclosure will now be described in detail, on the basis of examples, with reference to the drawings. However, the dimensions, materials, shapes, relative arrangements, and the like of the components described in the embodiments may be appropriately modified in accordance with the configurations and various conditions of apparatuses to which the present disclosure is applied. In other words, the scope of the present disclosure is not intended to be limited to the embodiment described below. In addition, while a plurality of features are described in the embodiments, all of the plurality of features are not necessarily essential to the disclosure, and the plurality of features may be combined with each other in any way. Moreover, in the accompanying drawings, the same reference numeral will be assigned to the same or similar component and overlapping descriptions will not be repeated.

### First Embodiment

### Overall Configuration

First, a first embodiment of the present disclosure will be described. An image forming apparatus 1 according to the first embodiment is an electrophotographic laser beam printer. Note that the image forming apparatus includes a printer, a copier, a facsimile, and a multifunction peripheral, and refers to an apparatus that forms an image on a sheet (recording material) used as a recording medium based on image information input from an external PC or image information read from a document. In addition to the main body having an image forming function, the image forming apparatus may be connected to peripheral devices such as an optional feeder, an image reading device, and a sheet processing device, and the entire system with such peripheral devices connected is also a type of image forming apparatus.

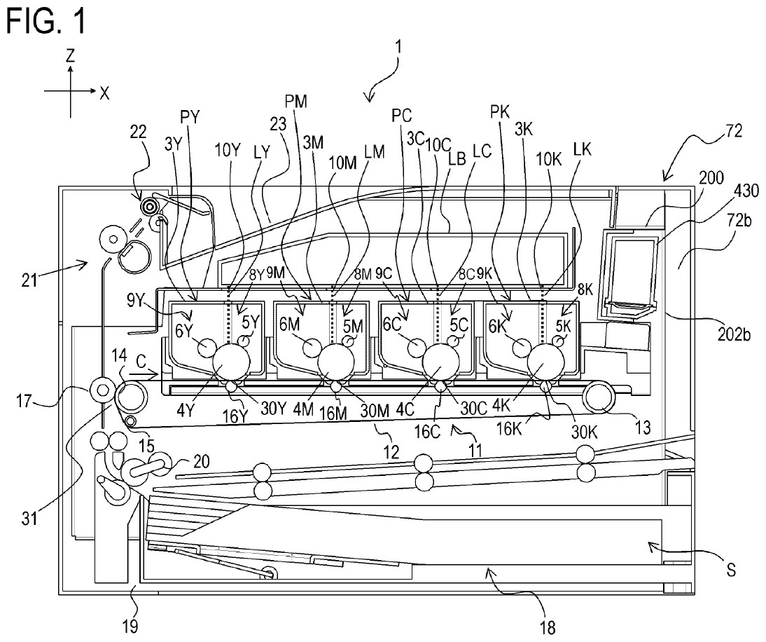

FIG. 1 is an overall schematic view illustrating the image forming apparatus 1 according to the first embodiment. As illustrated in FIG. 1, an image forming portion 40 that forms an image on a sheet S, a feeding unit 18, a fixing unit 21, and a discharge roller pair 22 are provided. The image forming portion 40 includes four process cartridges PY, PM, PC, and PK that form toner images of four colors of yellow (Y), magenta (M), cyan (C), and black (K), respectively, and a laser scanner LB. The laser scanner LB is disposed above the process cartridges PY, PM, PC, and PK. An LED exposure unit may be used in place of the laser scanner LB.

The part of the image forming apparatus 1 excluding the process cartridges PY, PM, PC, and PK and toner cartridges 430Y, 430M, 430C, and 430K described later may be referred to as a main body or an apparatus main body 72 of the image forming apparatus 1. Note that in the following description, the toner cartridges 430Y, 430M, 430C, and 430K may be simply referred to as cartridges 430Y, 430M, 430C, and 430K. The process cartridges PY, PM, PC, and PK may be detachably supported on the apparatus main body 72, or may be undetachably fixed to the apparatus main body 72.

In the present embodiment, parts corresponding to yellow, magenta, cyan, and black toners are denoted with subscripts P, Y, M, C, and K. The configuration and operation of the parts denoted with these subscripts are substantially the same except for the color of the toner. Therefore, unless it is necessary to distinguish them, the following description may be made collectively by omitting the subscripts Y to K.

In the following description, unless otherwise specified, it is assumed that the process cartridges PY, PM, PC, and PK and the toner cartridges 430Y, 430M, 430C, and 430K are in their normal posture, i.e., the posture when attached to the apparatus main body 72, and the directions (X, Y, Z) are defined as follows.

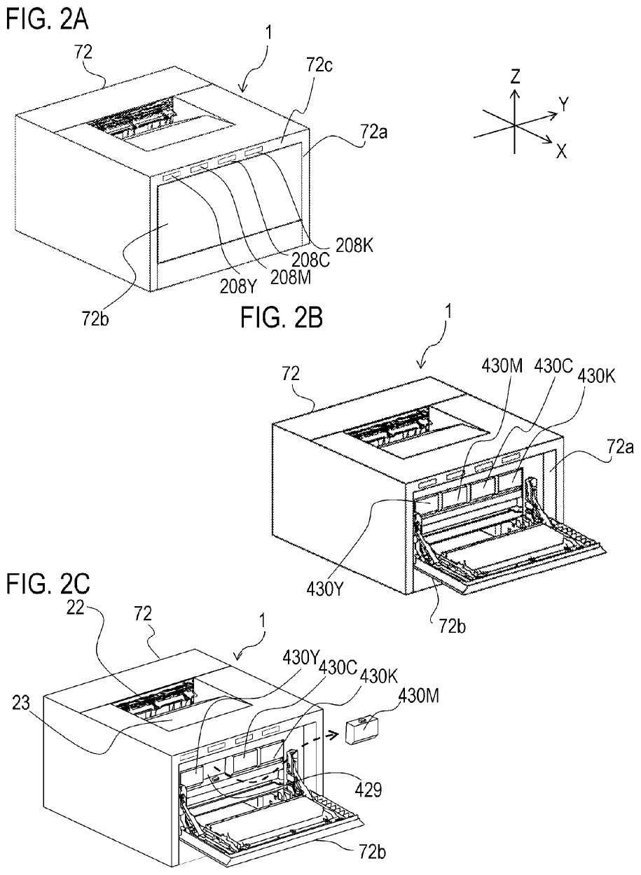

As illustrated in FIG. 2A, the front-rear direction is indicated by the X axis, and the direction from the rear to the front of the image forming apparatus 1 is defined as the X direction. The X direction may also be referred to as the forward direction or the frontward direction. Further, the downstream side in the X direction of the image forming apparatus 1 may be referred to as the front side, and the upstream side may be referred to as the rear side.

The left-right direction is indicated by the Y axis, and the direction from the left to the right of the image forming apparatus 1 is defined as the Y direction. The Y direction may also be referred to as the rightward direction. Further, the downstream side in the Y direction of the image forming apparatus 1 may be referred to as the right side, and the upstream side may be referred to as the left side.

The up-down direction is indicated by the Z axis, and the direction from the bottom to the top of the image forming apparatus 1 is defined as the Z direction. The Z direction may also be referred to as the upward direction, the height direction, or the vertical direction. Further, the downstream side in the Z direction of the image forming apparatus 1 may be referred to as the upper side, the top surface side, or the ceiling side, and the upstream side may be referred to as the lower side, the bottom surface side, or the floor side.

The X axis, Y axis, and Z axis are perpendicular to each other. For example, the X axis is perpendicular to the Y axis and also perpendicular to the Z axis. A plane perpendicular to the X axis may be referred to as the YZ plane, a plane perpendicular to the Y axis may be referred to as the ZX plane, and a plane perpendicular to the Z axis may be referred to as the XY plane. For example, the XY plane is a horizontal plane. The X direction and Y direction are directions along the horizontal XY plane, i.e., horizontal directions.

The process cartridge PY includes a drum unit 8Y and a developing unit 9Y. The drum unit 8Y includes a photosensitive drum 4Y and a charging roller 5Y. The photosensitive drum 4Y is formed by applying an organic photoconductive layer to the outer periphery of an aluminum cylinder and is rotated by a drive motor (not shown). A photosensitive belt may be used in place of the photosensitive drum 4Y. The developing unit 9Y includes a developer container 3M storing yellow toner and a developing roller 6Y developing the electrostatic latent image on the photosensitive drum 4Y.

Similarly, the process cartridge PM includes a drum unit 8M and a developing unit 9M. The drum unit 8M includes a photosensitive drum 4M and a charging roller 5M. The photosensitive drum 4M is formed by applying an organic photoconductive layer to the outer periphery of an aluminum cylinder, and is rotated by a drive motor (not shown). A photosensitive belt may be used in place of the photosensitive drum 4M. The developing unit 9M includes a developer container 3M storing the toner of magenta and a developing roller 6M developing the electrostatic latent image on the photosensitive drum 4M.

The process cartridge PC also includes a drum unit 8C and a developing unit 9C. The drum unit 8C includes a photosensitive drum 4C and a charging roller 5C. The photosensitive drum 4C is formed by applying an organic photoconductive layer to the outer periphery of an aluminum cylinder and is rotated by a drive motor (not shown). A photosensitive belt may be used in place of the photosensitive drum 4C. The developing unit 9C includes a developer container 3M storing cyan toner and a developing roller 6C developing an electrostatic latent image on a photosensitive drum 4C.

The process cartridge PK includes a drum unit 8K and a developing unit 9K. The drum unit 8K includes a photosensitive drum 4K and a charging roller 5K. The photosensitive drum 4K is constructed by applying an organic photoconductive layer to the outer periphery of an aluminum cylinder, and is rotated by a drive motor (not shown). A photosensitive belt may be used in place of the photosensitive drum 4K. The developing unit 9K includes a developer container 3M storing black toner and a developing roller 6K developing an electrostatic latent image on a photosensitive drum 4K.

These four process cartridges PY, PM, PC, and PK are arranged side by side in the X direction. Further, the image forming portion 40 is provided with an intermediate transfer belt unit 11 disposed below the process cartridges PY, PM, PC, and PK. The intermediate transfer belt unit 11 includes an intermediate transfer belt 12 stretched around a driver roller 14, a tension roller 13, and an assist roller 15, and a secondary transfer roller 17. The intermediate transfer belt 12 is rotated clockwise in FIG. 1 by the driver roller 14. On the inner side of the intermediate transfer belt 12, primary transfer rollers 16Y, 16M, 16C, and 16K are provided.

The primary transfer rollers 16Y, 16M, 16C, and 16K are in contact with the photosensitive drums 4Y, 4M, 4C, and 4K, respectively, thereby forming primary transfer portions 30Y, 30M, 30C, and 30K. The secondary transfer roller 17 is arranged to oppose the driver roller 14 via the intermediate transfer belt 12. The secondary transfer roller 17 and the intermediate transfer belt 12 are in contact with each other, thereby forming a secondary transfer portion 31.

The fixing unit 21 includes a fixing film 21a heated by a heater and a pressure roller 21b pressed against the fixing film 21a. The feeding unit 18 is provided at the lower part of the image forming apparatus 1. The feeding unit 18 includes a feed cassette 19 that can be pulled out from and mounted to the apparatus main body 72, and a feed roller 20 that feeds sheets S stored in the feed cassette 19. The feeding unit 18 has a manual feed port 330 for inserting sheets by hand. Here, “sheet” includes paper such as regular sheets and envelopes, plastic films such as overhead projector (OHP) sheets, and fabrics.

### Image Forming Operation

Next, the image forming operation of the image forming apparatus 1 constituted as described above will be explained. When an image signal is input from a computer (not shown) or the like to the laser scanner LB, the laser scanner LB emits laser beams LY, LM, LC, and LK corresponding to the image signal onto the photosensitive drums 4Y, 4M, 4C, and 4K, respectively.

At this time, the surface of the photosensitive drum 4Y has been uniformly charged to a predetermined polarity and potential in advance by the charging roller 5Y, and when the laser beam LY is emitted from the laser scanner LB, an electrostatic latent image is formed on the surface. The electrostatic latent image formed on the photosensitive drum 4Y is developed by the developing roller 6Y, thereby forming a yellow (Y) toner image on the photosensitive drum 4Y.

Similarly, magenta (M), cyan (C), and black (K) toner images are formed on the photosensitive drums 4M, 4C, and 4K, respectively. The toner images of each color formed on the respective photosensitive drums are transferred onto the intermediate transfer belt 12 by the primary transfer rollers 16Y, 16M, 16C, and 16K and are conveyed to the secondary transfer roller 17 by the intermediate transfer belt 12, which is rotated by the driver roller 14.

The image forming process for each color is performed at a timing such that the toner image is superimposed on the upstream toner image primarily transferred onto the intermediate transfer belt 12. After the toner images of each color are transferred onto the intermediate transfer belt 12, the toner remaining on the surface of each photosensitive drum is removed by a cleaning device (not shown).

In parallel with this image forming process, sheets S stored in the feed cassette 19 of the feeding unit 18 or sheets supplied from the manual feed port 330 are conveyed toward the secondary transfer portion 31. In the secondary transfer portion 31, the full-color toner image on the intermediate transfer belt 12 is transferred onto the sheet S by a secondary transfer bias applied to the secondary transfer roller 17. The sheet S onto which the toner image has been transferred is subjected to predetermined heat and pressure by the fixing film 21a and the pressure roller 21b of the fixing unit 21, thereby melting and fixing (fusing) the toner. The sheet S that has passed through the fixing unit 21 is discharged by the discharge roller pair 22 in the direction along the X direction and stacked on a discharge tray 23 provided at the upper part of the apparatus main body 72.

### Overall Configuration of Toner Cartridge

Next, a schematic configuration of the toner cartridges 430Y, 430M, 430C, and 430K will be described with reference to FIGS. 2A to 2C. FIG. 2A is a perspective view illustrating the image forming apparatus 1, FIG. 2B is a perspective view illustrating the image forming apparatus 1 in a state where a front door 72b is opened, and FIG. 2C is a perspective view illustrating the image forming apparatus 1 in a state where the toner cartridge 430M is removed.

As illustrated in FIG. 2A, the image forming apparatus 1 includes the front door 72b supported to be openable and closable with respect to the housing of the apparatus main body 72. As illustrated in FIGS. 2A and 2B, the front door 72b is located at the closed position to cover an opening 72a provided at the front portion of the apparatus main body 72, that is, at the downstream end in the X direction. As illustrated in FIG. 2B, the front door 72b is located at the open position to open the opening 72a of the apparatus main body 72. The front door 72b can maintain its posture at the open position.

As illustrated in FIG. 2B, when the front door 72b is opened from the closed position to the open position, the toner cartridges 430Y, 430M, 430C, and 430K are exposed to the outside of the image forming apparatus 1 through the opening 72a. Thus, the user can access the toner cartridges 430Y, 430M, 430C, and 430K. The toner cartridges 430Y, 430M, 430C, and 430K can supply toner to the developer containers 3Y, 3M, 3C, and 3K of the process cartridges PY, PM, PC, and PK as developer storing portions.

The toner cartridges 430Y, 430M, 430C, and 430K are arranged at the downstream side in the X direction and the downstream side in the Z direction of the apparatus main body 72, i.e., at the front side and the upper side of the apparatus main body 72. In other words, the toner cartridges 430Y, 430M, 430C, and 430K are arranged at the downstream side of the apparatus main body 72 in the sheet discharge direction of the discharge roller pair 22. Further, the toner cartridges 430Y, 430M, 430C, and 430K are arranged side by side in the Y direction. That is, the X direction, in which the process cartridges PY, PM, PC, and PK are arranged, and the Y direction, in which the toner cartridges 430Y, 430M, 430C, and 430K are arranged, intersect each other.

As illustrated in FIG. 2C, the toner cartridges 430Y, 430M, 430C, and 430K are detachably supported in the X direction by a cartridge holder 429 (mounting portion) provided in the apparatus main body 72. Therefore, the toner cartridges 430Y, 430M, 430C, and 430K can be replaced without removing the process cartridges PY, PM, PC, and PK from the apparatus main body 72. Since the toner cartridges 430Y, 430M, 430C, and 430K are arranged at the front side of the apparatus main body 72 and are exposed when the front door 72b is opened, they can be easily replaced.

The cartridge holder 429 is arranged at the front side of the apparatus main body 72 and downstream of the process cartridges PY, PM, PC, and PK in the X direction. Therefore, even when the toner cartridges 430Y, 430M, 430C, and 430K are removed from the cartridge holder 429, the process cartridges PY, PM, PC, and PK are covered by the cartridge holder 429. Therefore, even in this case, the process cartridges PY, PM, PC, and PK are not exposed to the outside of the image forming apparatus 1 through the opening 72a. The toner cartridges 430Y, 430M, 430C, and 430K are housed inside the apparatus main body 72 when the front door 72b is in the closed position.

Further, as illustrated in FIG. 2A, indicators 208Y, 208M, 208C, and 208K are provided on the front surface 72c of the apparatus main body 72. These indicators 208Y, 208M, 208C, and 208K are for clearly indicating to the user the color of the toner stored in the toner cartridges 430Y, 430M, 430C, and 430K. The indicators 208Y, 208M, 208C, and 208K are configured by LEDs, seals, or the like, and for example, the indicator 208Y is constituted by an LED that lights up or blinks in yellow, or by a seal colored in yellow. The indicators 208Y, 208M, 208C, and 208K may also be provided with a function for displaying the remaining amount of toner stored in the corresponding process cartridges PY, PM, PC, and PK.

In the present embodiment, the indicators 208Y, 208M, 208C, and 208K are provided on the front surface 72c of the apparatus main body 72 and are not covered by the front door 72b in the closed position. That is, the indicators 208Y, 208M, 208C, and 208K are exposed to the outside of the image forming apparatus 1 regardless of the position of the front door 72b. However, for example, the indicators 208Y, 208M, 208C, and 208K may be arranged so as to be covered by the front door 72b in the closed position and exposed to the outside when the front door 72b is opened.

### Image Forming Unit

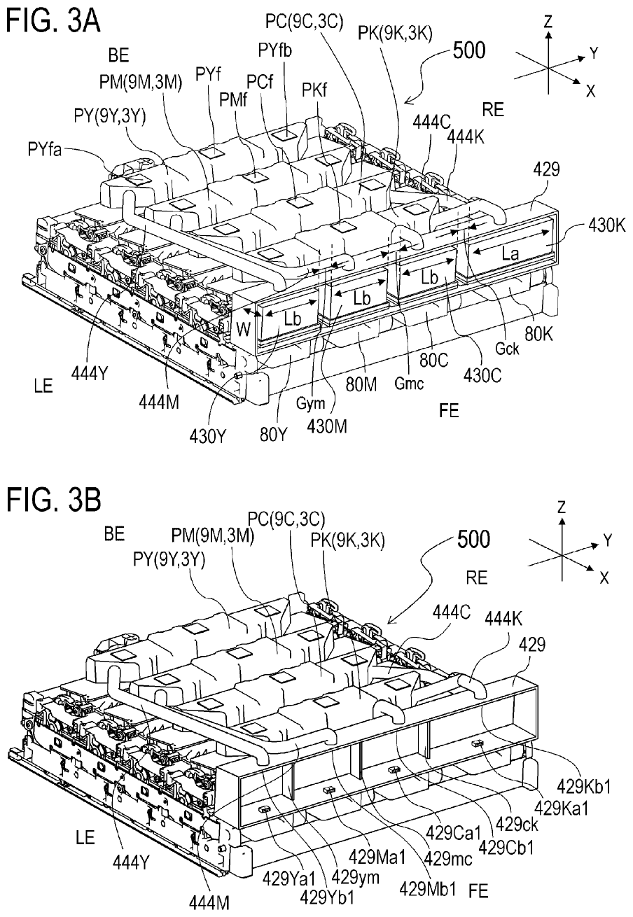

Next, an image forming unit 500 including a toner conveying mechanism for conveying toner from the toner cartridges 430Y, 430M, 430C, and 430K to the process cartridges PY, PM, PC, and PK will be described with reference to FIGS. 3A and 3B to FIG. 8. FIG. 3A is a perspective view illustrating the image forming unit 500, and FIG. 3B is a perspective view illustrating the image forming unit 500 in a state where the toner cartridges 430Y, 430M, 430C, and 430K are removed.

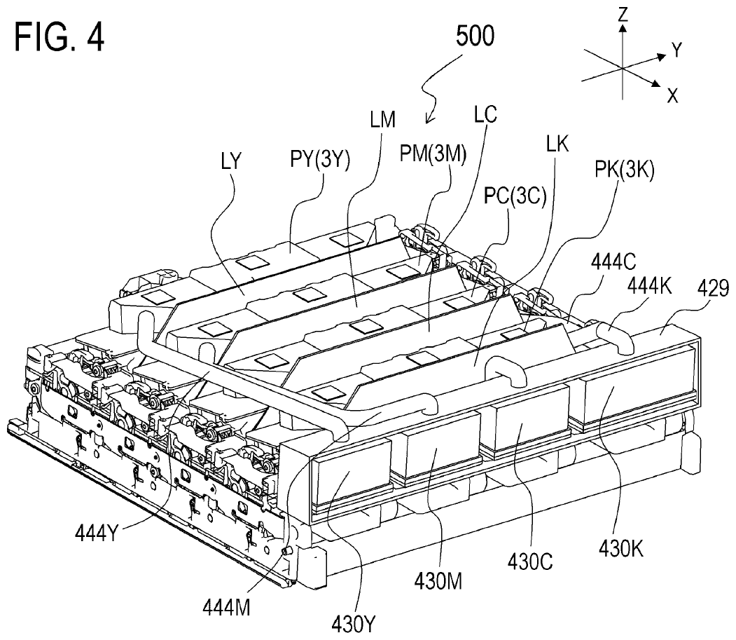

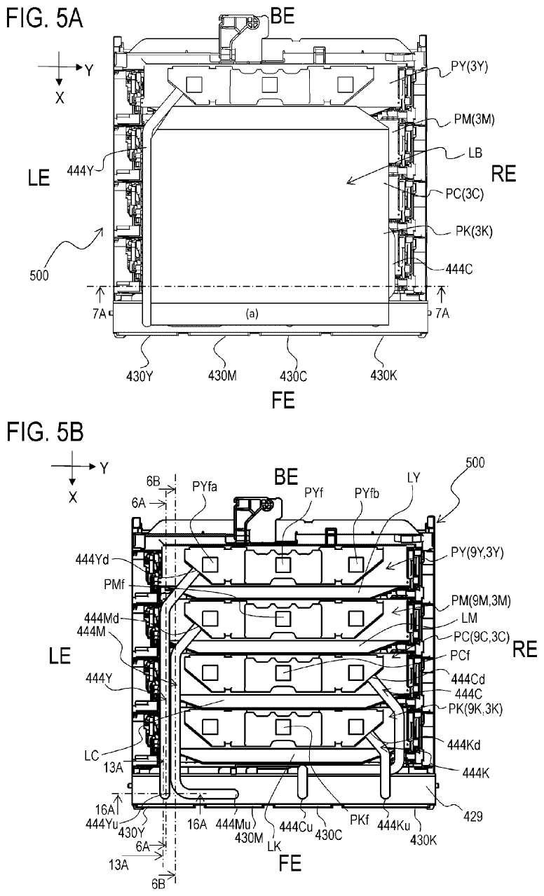

FIG. 4 is a perspective view illustrating optical paths LY1, LM1, LC1, and LK1 of the laser beams LY, LM, LC, and LK emitted from the laser scanner LB. In FIGS. 4, 5B, and 7, the optical paths LY1, LM1, LC1, and LK1 are visualized for convenience. FIG. 5A is a plan view illustrating the laser scanner LB and the image forming unit 500, and FIG. 5B is a plan view illustrating the image forming unit 500.

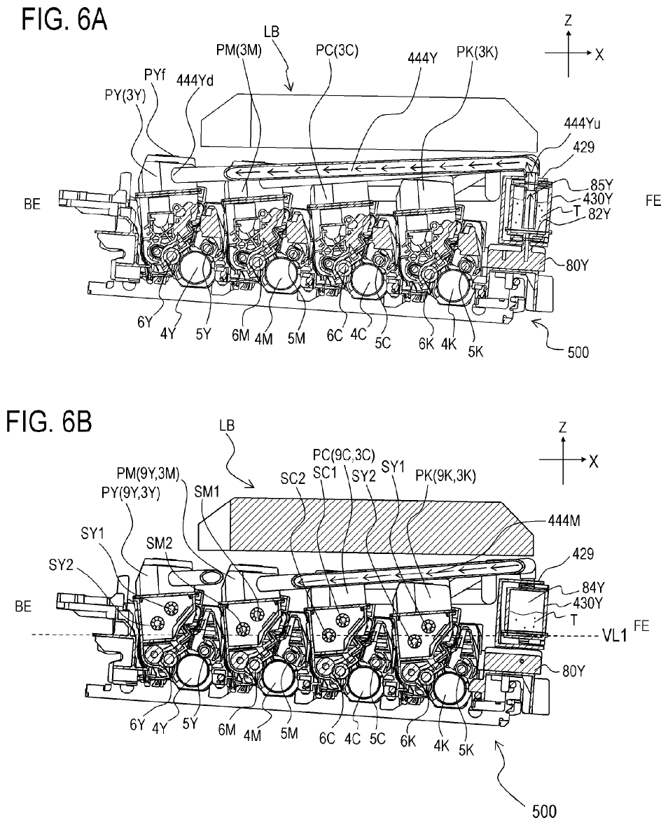

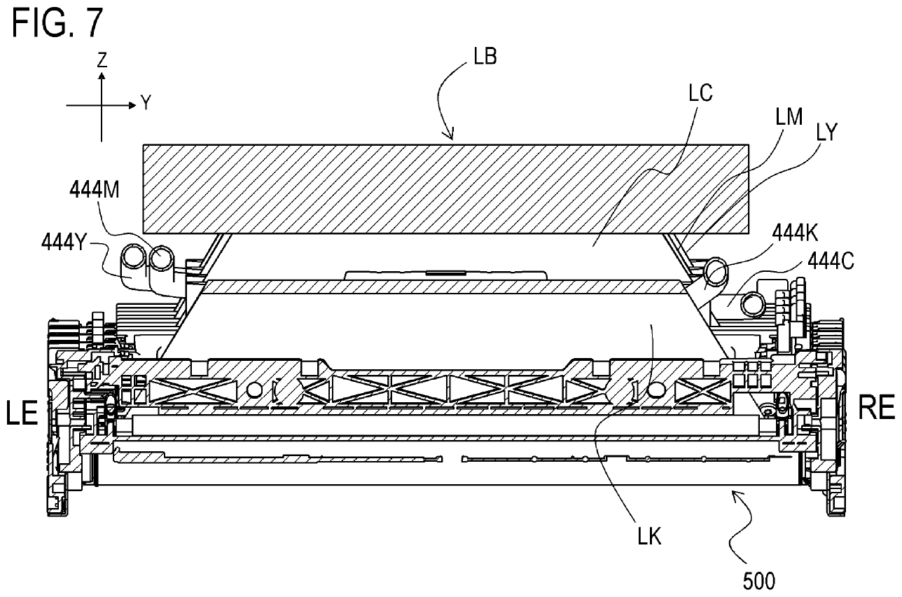

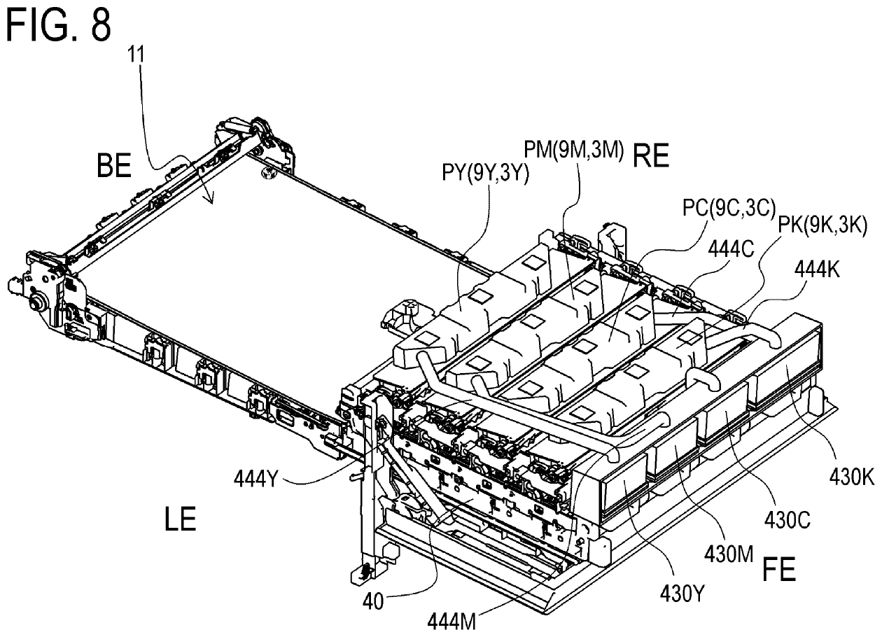

FIG. 6A is a cross-sectional view illustrating a cross section taken along line 6A-6A of FIG. 5B, and FIG. 6B is a cross-sectional view illustrating a cross section taken along line 6B-6B of FIG. 5B. FIG. 7 is a cross-sectional view illustrating a cross section taken along line 7A-7A of FIG. 5A. FIG. 8 is a perspective view illustrating a state in which the image forming unit 500 is pulled out from the apparatus main body 72.

As shown in FIGS. 3A and 4, the image forming unit 500 includes the process cartridges PY, PM, PC, and PK, the toner cartridges 430Y, 430M, 430C, and 430K, the cartridge holder 429, and pump units 80Y, 80M, 80C, and 80K. The pump units 80Y, 80M, 80C, and 80K are arranged below the cartridge holder 429 and are arranged side by side in the Y direction. The pump units 80Y, 80M, 80C, and 80K are constituted by a positive displacement pump such as a reciprocating pump or a rotary pump, but are not limited thereto. For example, the pump units 80Y, 80M, 80C, and 80K may be constituted by non-positive displacement pumps such as centrifugal pumps, propeller pumps, or viscous pumps.

A reciprocating pump is a pump that performs suction and discharge by the reciprocating motion of a piston or plunger, and includes piston pumps, plunger pumps, and diaphragm pumps. A rotary pump is a pump that performs suction and discharge by rotating gears or rotors, and includes gear pumps, screw pumps, and vane pumps. The four pump units 80Y, 80M, 80C, and 80K may be constituted as a single pump unit, or as two or three pump units. In the present embodiment, the pump units 80Y, 80M, 80C, and 80K are provided in the apparatus main body 72, but may also be provided in the toner cartridges 430Y, 430M, 430C, and 430K, respectively.

The pump units 80Y, 80M, 80C, and 80K have discharge ports 80Ya, 80Ma, 80Ca, and 80Ka for discharging air, and these discharge ports 80Ya, 80Ma, 80Ca, and 80Ka are open in the upward direction, i.e., the Z direction.

The bottom surface of the cartridge holder 429 is provided with openings respectively facing the discharge ports 80Ya, 80Ma, 80Ca, and 80Ka, air discharge port covers 429Ya1, 429Ma1, 429Ca1, and 429Ka1 that cover the discharge ports 80Ya, 80Ma, 80Ca, and 80Ka as illustrated in FIG. 3B, and discharge port seals 429Ya2, 429Ma2, 429Ca2, and 429Ka2. On the upper surface of the cartridge holder 429, holder discharge ports 429Yb3, 429Ma3, 429Ca3, and 429Ka3 opened in the Z direction, holder discharge port covers 429Yb1, 429Mb1, 429Cb1, and 429Kb1 covering the holder discharge ports, and holder discharge port seals 429Yb2, 429Mb2, 429Cb2, and 429Kb2 are provided. Further, the cartridge holder 429 is provided with division portions 429ym, 429mc, and 429ck that divide the respective cartridges.

In the state where the toner cartridges 430Y, 430M, 430C, and 430K are mounted to the cartridge holder 429, the air discharged from the discharge ports 80Ya, 80Ma, 80Ca, and 80Ka is supplied into the interiors of the toner cartridges 430Y, 430M, 430C, and 430K. The toner discharged from the toner cartridges 430Y, 430M, 430C, and 430K together with the air is received by the supply pipes 444Y, 444M, 444C, and 444K via the holder discharge ports 429Yb3, 429Ma3, 429Ca3, and 429Ka3 of the cartridge holder 429.

The supply pipes 444Y, 444M, 444C, and 444K include upstream ends 444Yu, 444Mu, 444Cu, and 444Ku connected to the respective discharge ports 429Ya, 429Ma, 429Ca, and 429Ka, and downstream ends 444Yd, 444Md, 444Cd, and 444Kd connected to the respective developer containers 3Y, 3M, 3C, and 3K.

The toner discharged from the toner cartridges 430Y, 430M, 430C, and 430K together with the air is supplied to the developer containers 3Y, 3M, 3C, and 3K through the supply pipes 444Y, 444M, 444C, and 444K.

The downstream ends 444Yd and 444Md of the supply pipes 444Y and 444M are connected to the upstream ends in the Y direction, i.e., the left ends, of the developer containers 3Y and 3M, respectively. The downstream ends 444Cd and 444Kd of the supply pipes 444C and 444K are connected to the downstream ends in the Y direction, i.e., the right ends, of the developer containers 3C and 3K, respectively. By thus distributing the supply pipes 444Y, 444M, 444C, and 444K to the left and right sides of the developer containers 3Y, 3M, 3C, and 3K, the lengths of the supply pipes 444Y, 444M, 444C, and 444K can be decreased. Therefore, pressure losses in the supply pipes 444Y, 444M, 444C, and 444K can be reduced, and the image forming unit 500 can be made more compact.

Next, the arrangement of the toner cartridge 430Y will be described. As illustrated in FIG. 6B, the toner cartridge 430Y and the process cartridges PY, PM, PC, and PK are arranged so as to overlap a virtual line VLI extending in the X direction. That is, as illustrated in FIGS. 1 and 6B, the toner cartridges 430Y, 430M, 430C, and 430K are arranged side by side with the process cartridges PY, PM, PC, and PK in the X direction. In other words, when viewed in the X direction, at least parts of the toner cartridges 430Y, 430M, 430C, and 430K are arranged so as to overlap with the process cartridges PY, PM, PC, and PK in the Z direction. Accordingly, the image forming unit 500 can be made more compact in the Z direction, i.e., the up-down direction, and the image forming apparatus 1 can be made more compact.

In the present embodiment, the toner cartridges 430Y, 430M, 430C, and 430K are arranged as described above, but the arrangement is not limited thereto. That is, the toner cartridges 430Y, 430M, 430C, and 430K may be arranged above the process cartridges PY, PM, PC, and PK in the Z direction.

Next, the arrangement of the supply pipes 444Y, 444M, 444C, and 444K will be described. As illustrated in FIGS. 4, 5B, and 7, the supply pipes 444Y, 444M, 444C, and 444K are disposed so as not to interfere with the optical paths LY1, LM1, LC1, and LK1 described above. As a result, the image forming unit 500 and the image forming apparatus 1 can be made more compact. In particular, the image forming unit 500 can be made more compact in both the Y direction and the Z direction.

Also, the image forming unit 500 may have a configuration in which the process cartridges PY, PM, PC, and PK and the supply pipes 444Y, 444M, 444C, and 444K can be easily accessed for maintenance or replacement of the process cartridges PY, PM, PC, and PK and the supply pipes 444Y, 444M, 444C, and 444K. Therefore, in the present embodiment, as illustrated in FIG. 8, the image forming unit 500 is configured to be pulled out in the X direction relative to the apparatus main body 72, which includes the intermediate transfer belt unit 11. As a result, the maintainability of the image forming unit 500 can be improved. Note that the image forming unit 500 may also be configured so that it cannot be pulled out in the X direction relative to the apparatus main body 72.

### Overall Configuration of Toner Cartridge

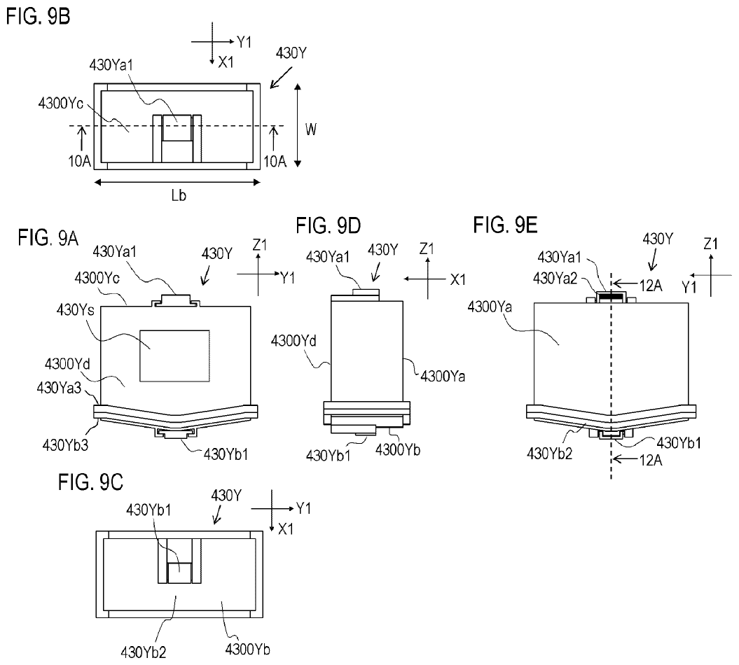

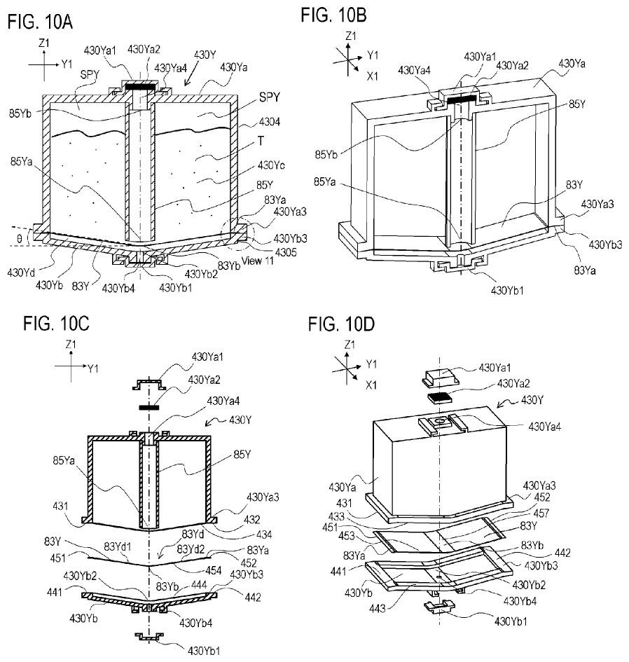

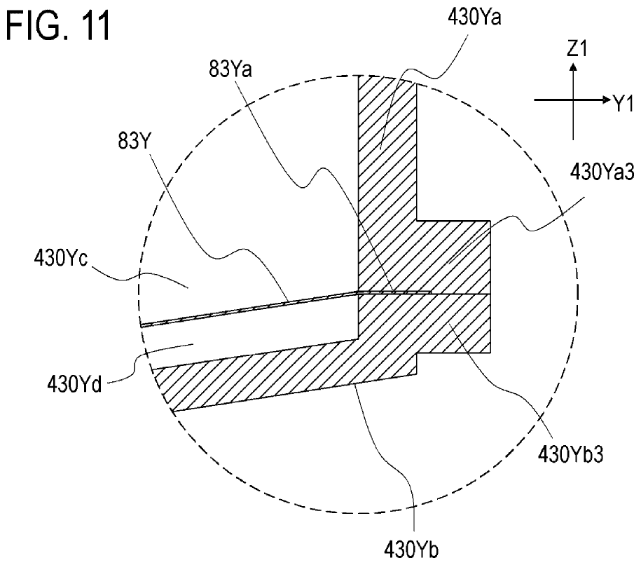

Next, a schematic configuration of the toner cartridge 430Y as a cartridge will be described with reference to FIGS. 9A to 9E to FIG. 11. FIG. 9A is a front view illustrating the toner cartridge 430Y, and FIG. 9B is a top view illustrating the toner cartridge 430Y. FIG. 9C is a bottom view illustrating the toner cartridge 430Y, FIG. 9D is a side view illustrating the toner cartridge 430Y, and FIG. 9E is a rear view illustrating the toner cartridge 430Y. FIGS. 10A, 10B, and 10C illustrate cross sections taken along line 10A-10A of FIG. 9B, respectively. FIG. 10A illustrates a front view, FIG. 10B illustrates a perspective view, and FIG. 10C illustrates an exploded front view. FIG. 10D is an exploded perspective view illustrating the toner cartridge 430Y. FIG. 11 is a partially enlarged view illustrated in View 11 of FIG. 10A illustrating a joint portion between the first frame and the second frame.

As illustrated in FIG. 3A, the toner cartridge 430K has a width La in the Y direction, and the width La is greater than the respective widths Lb1 of the toner cartridges 430Y, 430M, and 430C. Therefore, the capacity for storing toner in the toner cartridge 430K is larger than that of each of the toner cartridges 430Y, 430M, and 430C. Generally, black toner is consumed more than other color toners, but as described above, the toner cartridge 430K can store more toner than the other toner cartridges 430Y, 430M, and 430C. Accordingly, it is possible to equalize the replacement frequency among the toner cartridges 430Y, 430M, 430C, and 430K and to improve usability.

In the present embodiment, the lengths of the toner cartridges 430Y, 430M, 430C, and 430K in the X direction are equal, and are denoted as length W. The length W in the X direction is shorter than the widths La and Lb1 in the Y direction.

The toner cartridges 430Y, 430M, 430C, and 430K have the same configuration except for the width in the Y direction. Therefore, only the toner cartridge 430Y will be described below, and the description of the toner cartridges 430M, 430C, and 430K will be omitted.

Furthermore, in the following description, unless otherwise specified, directions (X1, Y1, Z1) are defined as illustrated in FIGS. 9A to 9E to FIGS. 12A and 12B on the assumption that the toner cartridge 430Y takes a posture described below. In other words, the description will be made on the assumption of the posture of the toner cartridge 430Y such that a toner storage chamber 430Yc, a filter 83Y, and an air chamber 430Yd are arranged in this order with respect to the gravitational direction G (the direction opposite to the Z1 direction; referring to FIG. 10A) as a first direction and the short side direction (X1 direction) and the long side direction (Y1 direction) of the toner cartridge 430Y are parallel to the horizontal direction perpendicular to the gravitational direction G. In this posture, the direction opposite to the Z1 direction is the gravitational direction, and the toner cartridge 430Y is directed in a predetermined direction in which the toner storage chamber 430Yc is above the air chamber 430Yd. In this state, the short side direction of the toner cartridge 430Y is defined as the X1 direction, the long side direction as the Y1 direction, and the direction opposite to the gravitational direction as the Z1 direction. That is, the first direction, which is the gravitational direction G, is the direction in which the second frame 430Yb and the first frame 430Ya are aligned. The second direction, which is the Y1 direction, is the long side direction of the first frame 430Ya, which intersects the Z1 direction in a cross-section perpendicular to the Z1 direction. The third direction, which is the X1 direction, is the short side direction of the first frame 430Ya, which intersects both the Z1 and Y1 directions.

The front-rear direction of the toner cartridge 430Y is indicated by the X1 axis, and the direction from the rear to the front of the toner cartridge 430Y is defined as the X1 direction. The X1 direction may also be referred to as the forward direction or the frontward direction. Further, the downstream side in the X1 direction of the toner cartridge 430Y may be referred to as the front side, and the upstream side may be referred to as the rear side.

The left-right direction of the toner cartridge 430Y is indicated by the Y1 axis, and the direction from the left to the right of the toner cartridge 430Y is defined as the Y1 direction. The Y1 direction may also be referred to as the rightward direction. Further, the downstream side in the Y1 direction of the toner cartridge 430Y may be referred to as the right side, and the upstream side may be referred to as the left side.

The up-down direction of the toner cartridge 430Y is indicated by the Z1 axis, and the direction from the bottom to the top of the toner cartridge 430Y is defined as the Z1 direction. The Z1 direction may also be referred to as the upward direction, the height direction, or the vertical direction. Further, the downstream side in the Z1 direction of the toner cartridge 430Y may be referred to as the upper side, the top surface side, or the ceiling side, and the upstream side may be referred to as the lower side, the bottom surface side, or the floor side.

The X1 axis, the Y1 axis, and the Z1 axis are perpendicular (orthogonal) to each other. For example, the X1 axis is perpendicular to the Y1 axis and also perpendicular to the Z1 axis. A plane perpendicular to the X1 axis may be referred to as the Y1Z1 plane, a plane perpendicular to the Y1 axis as the Z1X1 plane, and a plane perpendicular to the Z1 axis as the X1Y1 plane.

As illustrated in FIGS. 9A to 9E and FIGS. 10A to 10D, the toner cartridge 430Y includes a first frame 430Ya, a discharge port cover 430Ya1, a discharge port seal 430Ya2, a discharge pipe 85Y, a second frame 430Yb, an intake port cover 430Yb1, and a filter 83Y. The discharge port cover 430Ya1 (first cover portion) is held by the first frame 430Ya so as to be movable in the X1 direction (second direction) between a discharge port closed position (first closed position) where the discharge port 430Ya4 is covered (closed) and a discharge port open position (first open position) where the discharge port 430Ya4 is exposed (opened). The intake port cover 430Yb1 (second cover portion) is held by the second frame 430Yb so as to be movable in the X1 direction (second direction) between an intake closed position (second closed position) where an intake port 430Yb4 is covered (closed) and an intake open position (second open position) where the intake port 430Yb4 is exposed (opened). In the present embodiment, the first frame 430Ya, the second frame 430Yb, the discharge port cover 430Ya1, and the intake port cover 430Yb1 are made of a resin material, but may be made of paper or the like. The discharge port seal 430Ya2 is made of a flexible member such as sponge or elastomer. Although details will be described later, the filter 83Y is fixed in a state of being sandwiched between the first frame 430Ya and the second frame 430Yb.

As illustrated in FIG. 9A, a label 430Ys is provided on the front surface 4300d of the toner cartridge 430Y. The label 430Ys is for indicating the color of the toner stored in the toner cartridge 430Y. Note that the label 430Ys is omitted in the drawings other than FIG. 9A. The label 430Ys may also display information on how to mount the toner cartridge 430Y to the cartridge holder 429, or other information regarding the toner cartridge 430Y. For example, the label 430Ys may indicate the toner capacity of the toner cartridge 430Y, the expiration date of the toner, storage instructions for the toner cartridge 430Y, or instructions for removing the above-mentioned sealing member.

An internal space SPY of the toner cartridge 430Y is divided (partitioned) by the filter 83Y into the toner storage chamber 430Yc (developer storage chamber) and the air chamber 430Yd. That is, the toner storage chamber 430Yc is configured (defined) by (the inner wall of) the first frame 430Ya and the filter 83Y, and the air chamber 430Yd is configured (defined) by (the inner wall of) the second frame 430Yb and the filter 83Y. The air chamber 430Yd is arranged below the filter 83Y, and the toner storage chamber 430Yc is arranged above the filter 83Y.

The toner storage chamber 430Yc is configured to store the toner T (see FIG. 10A), and the toner T is supported in the gravitational direction by the filter 83Y in the toner storage chamber 430Yc. No toner T is stored in the air chamber 430Yd. The filter 83Y is made of, for example, a porous member composed of resin fibers. The pores of the filter 83Y are of a size and density that allow the passage of air but restrict the passage of toner T. In other words, the filter 83Y is configured to allow the passage of air and to prevent the passage of toner T.

As illustrated in FIGS. 10A to 10D, an upper surface 4300Yc of the first frame 430Ya is provided with a discharge port 430Ya4 through which the toner in the toner storage chamber 430Yc is discharged to the outside of the toner cartridge 430Y. The discharge port 430Ya4 is a container opening including a through port penetrating the upper surface 4300Yc of the first frame 430Ya in the Z1 direction (first direction). The discharge port cover 430Ya1 and the discharge port seal 430Ya2 are attached to the upper surface 4300Yc of the first frame 430Ya so as to cover the discharge port 430Ya4.

A bottom surface 4300Yb of the second frame 430Yb is provided with the intake port 430Yb4 as a container opening including a through port penetrating in the Z1 direction (first direction), and the intake port cover 430Yb1 is configured to cover the intake port 430Yb4. The discharge port 430Ya4 and the intake port 430Yb4 communicate with the outside of the toner cartridge 430Y. The discharge port 430Ya4 is provided on one end surface of the toner cartridge 430Y in the Z1 direction (first direction), and the intake port 430Yb4 is provided on the other end surface of the toner cartridge 430Y in the Z1 direction (first direction). The discharge port 430Ya4 and the intake port 430Yb4 are arranged to have regions overlapping each other when viewed in the Z1 direction.

The discharge port 430Ya4 and the intake port 430Yb4 may be provided on sides other than both left and right side surfaces of the toner cartridge 430Y. In other words, the discharge port 430Ya4 and the intake port 430Yb4 may be provided on side surfaces of the toner cartridge 430Y other than the side surfaces facing the Y1 direction (third direction), which is the direction in which the toner cartridges 430Y, 430M, 430C, and 430K are aligned. Accordingly, it is possible to decrease the gaps Gym, Gmc, and Gck in the Y direction (Y1 direction) between the respective toner cartridges 430Y, 430M, 430C, and 430K, as illustrated in FIG. 3A. As a result, the width in the Y direction of the toner cartridges 430Y, 430M, 430C, and 430K can be increased, and the capacity for storing toner in the toner cartridges 430Y, 430M, 430C, and 430K can be increased.

The gap Gym is the gap in the Y direction between the toner cartridge 430Y and the toner cartridge 430M. The gap Gmc is the gap in the Y direction between the toner cartridge 430M and the toner cartridge 430C. The gap Gck is the gap in the Y direction between the toner cartridge 430C and the toner cartridge 430K.

Further, as illustrated in FIG. 10A, the bottom surface 4300Yb of the second frame 430Yb is inclined downward (upstream in the Z direction) toward the center in the Y1 direction. That is, the bottom surface 4300Yb has a first inclined surface 4302 that slopes downward as it proceeds downstream in the Y1 direction, and a second inclined surface 4303 that slopes downward as it proceeds upstream in the Y1 direction. The boundary portion between the first inclined surface 4302 and the second inclined surface 4303 is the lowest surface portion 430Yb2 of the bottom surface 4300Yb.

### Toner Conveying Mechanism

Next, a mechanism by which the toner stored in the toner storage chamber 430Yc of the toner cartridge 430Y is conveyed to the developer container 3Y of the process cartridge PY will be described. As illustrated in FIG. 6A, air discharged from the discharge port 80Ya of the pump unit 80Y is introduced into the air chamber 430Yd via the intake port 430Yb4 of the toner cartridge 430Y (see FIG. 10A). This air fills the air chamber 430Yd, passes through the filter 83Y, and flows into the toner storage chamber 430Yc.

The air flowing into the toner storage chamber 430Yc enters between the particles of toner T and fluidizes the toner T. Due to the inflow of air from the pump unit 80Y, the inside of the toner cartridge 430Y becomes positively pressurized, and the air attempts to exit the toner cartridge 430Y through the discharge port 430Ya4 via the discharge pipe 85Y. At this time, the toner T in the toner storage chamber 430Yc is moved in the discharge pipe 85Y together with air, and is discharged from the discharge port 430Ya4 to the outside of the toner cartridge 430Y. In other words, the discharge pipe 85Y guides the toner in the toner storage chamber 430Yc together with air from an inlet 85Ya to the discharge port 430Ya4.

The toner T discharged from the discharge port 430Ya4 enters the upstream end 444Yu of the supply pipe 444Y via the holder discharge port 429Yb3 of the cartridge holder 429. The toner T is then conveyed through the inside of the supply pipe 444Y by the air that has also entered the supply pipe 444Y, and is supplied to the developer container 3Y of the process cartridge PY from the downstream end 444Yd of the supply pipe 444Y. As illustrated in FIG. 5B, since the downstream end 444Yd of the supply pipe 444Y is connected to the upstream end in the Y direction (Y1 direction) of the developer container 3Y, the toner T is supplied to the upstream end in the Y direction of the developer container 3Y.

Here, inside the developer container 3Y, as illustrated in FIG. 6B, stirring members SY1 and SY2 for stirring the toner in the developer container 3Y are rotatably provided. Similarly, inside the developer containers 3M, 3C, and 3K, sets of stirring members SY1 and SY2, SM1 and SM2, SC1 and SC2, and SK1 and SK2 are provided, respectively.

The toner in the developer container 3Y is leveled and conveyed in the Y direction (Y1 direction) by the rotation of the stirring members SY1 and SY2. In the present embodiment, these stirring members are constituted by a rotating shaft and a sheet member fixed to the rotating shaft, but the configuration is not limited thereto. For example, the stirring members may be constituted by screws configured to convey the toner in the developer container along the Y direction. That is, the stirring members SY1, SY2, SM1, and SM2 may be constituted by screws that convey the toner downstream in the Y direction, and the stirring members SC1, SC2, SK1, and SK2 may be constituted by screws that convey the toner upstream in the Y direction.

Since not only toner T but also air flows into the developer container 3Y, the internal pressure of the developer container 3Y rises. Therefore, in the present embodiment, a through hole (not shown) is provided on the top surface of the developer container 3Y and covered by an exhaust filter PYf as illustrated in FIGS. 3A and 5B. The exhaust filter PYf is made of nonwoven fabric or the like and is configured to allow the passage of air while restricting the passage of toner. Thus, the toner that has flowed into the developer container 3Y is prevented from being discharged to the outside by the exhaust filter PYf and remains in the developer container 3Y. On the other hand, at least a portion of the air that has flowed into the developer container 3Y passes through the exhaust filter PYf and is discharged to the outside of the developer container 3Y. As a result, the rise in internal pressure in the developer container 3Y can be suppressed and the developer container 3Y can be supplied with toner smoothly.

Similarly, exhaust filters PMf, PCf, and PKf and through holes (not shown) covered by these exhaust filters PMf, PCf, and PKf are provided on the top surfaces of the developer containers 3M, 3C, and 3K.

The exhaust filter PYf and the through hole are provided in a central portion of the developer container 3Y in the Y direction. The number of the exhaust filters and the through holes is not limited to one, and a plurality of the exhaust filters and the through holes may be provided in the developer container 3Y. For example, as illustrated in FIGS. 3A and 5B, the exhaust filters PYfa and PYfb may be provided in the developer container 3Y in addition to the exhaust filter PYf. The exhaust filters PYfa and PYfb cover through holes (not shown) provided in the developer container 3Y. The exhaust filter PYfa is arranged upstream of the exhaust filter PYf in the Y direction, and the exhaust filter PYfb is arranged downstream of the exhaust filter PYf in the Y direction. By providing a plurality of exhaust filters and through holes for a single developer container in this manner, the rise in internal pressure in the developer container can be efficiently suppressed.

As described above, the toner stored in the toner cartridge 430Y is conveyed together with air to the developer container 3Y and supplied to the developer container 3Y. In a configuration where the direction of the conveying path changes midway, as in the supply pipes 444Y, 444M, 444C, and 444K of the present embodiment, or where the conveying passage differs depending on the color of the toner, the toner can be conveyed using air. By conveying the toner using air, the degree of freedom in designing the toner conveying passage is increased, and components such as screws for conveying the toner are unnecessary, thereby reducing the number of parts and lowering the cost.

### Detailed Configuration of Toner Cartridge

### Frame

Next, a detailed configuration of the toner cartridge 430Y will be described with reference to FIGS. 10A to 10D to FIGS. 12A and 12B. As illustrated in FIGS. 10A to 10D to FIGS. 12A and 12B, the first frame 430Ya includes a first box portion 4304 and a first flange portion 430Ya3. The first box portion 4304 forms a toner storage chamber 430Yc together with a bottom surface portion 83Yd of the filter 83Y. The first flange portion 430Ya3 extends in the substantially horizontal direction from the lower end of the first box portion 4304 toward the outside of the toner storage chamber 430Yc. The first box portion 4304 is formed in a substantially rectangular parallelepiped shape. The first flange portion 430Ya3 is formed around the entire circumference of the lower end of the first box portion 4304. The second frame 430Yb is formed separately from the first frame 430Ya. The second frame 430Yb includes a second box portion 4305 that forms the air chamber 430Yd together with the bottom surface portion 83Yd of the filter 83Y, and a second flange portion 430Yb3 that extends from the upper end of the second box portion 4305 substantially horizontally outward from the air chamber 430Yd. The second flange portion 430Yb3 is formed around the entire circumference of the upper end of the second box portion 4305.

### Filter

The filter 83Y is formed in a rectangular sheet shape. The filter 83Y has a bottom surface portion 83Yd and an outer edge portion 83Ya. The bottom surface portion 83Yd functions as a division portion that divides the air chamber 430Yd and the toner storage chamber 430Yc. The outer edge portion 83Ya functions as a sandwiched portion which is sandwiched and held by the first flange portion 430Ya3 and the second flange portion 430Yb3. The outer edge portion 83Ya is provided so as to be continuous with the bottom surface portion 83Yd. The bottom surface portion 83Yd is formed so as to approach a lowest portion 83Yb of the filter 83Y in the long side direction (Y1 direction) as it goes downward in the gravitational direction G, and constitutes the bottom surface of the toner storage chamber 430Yc. In other words, when viewed in the X1 direction, the bottom surface portion 83Yd is inclined downward toward the lowest portion 83Yb in the gravitational direction G as approaching the lowest portion 83Yb of the filter 83Y in the Y1 direction. As illustrated in FIG. 10C, the bottom surface portion 83Yd has a first inclined surface 83Yd1 and a second inclined surface 83Yd2. The first inclined surface 83Yd1 is an inclined surface inclined downward from one end (upstream end) of the bottom surface portion 83Yd toward the lowest portion 83Yb in the Y1 direction. The second inclined surface 83Yd2 is an inclined surface that is inclined downward from the other end (downstream end) of the bottom surface portion 83Yd toward the lowest portion 83Yb in the Y1 direction.

In other words, when viewed in the X1 direction, assuming that the two ends of the toner cartridge 430Y in the Y1 direction are defined as a first end and a second end, the lowest portion 83Yb of the filter 83Y is arranged between the first end and the second end in the Y1 direction. The first inclined surface 83Yd1 as the first portion is configured to be directed downward from the first end toward the lowest portion 83Yb in the Y1 direction. The second inclined surface 83Yd2 as the second portion is configured to be directed downward from the second end toward the lowest portion 83Yb in the Y1 direction.

In addition, the bottom surface portion 83Yd is provided between the first inclined surface 83Yd1 and the second inclined surface 83Yd2 in the Y1 direction, and includes an intermediate portion 457 in which the lowest portion 83Yb is located. The intermediate portion 457 is curved so as to smoothly connect the first inclined surface 83Yd1 and the second inclined surface 83Yd2. Alternatively, the intermediate portion 457 may be omitted, and the first inclined surface 83Yd1 and the second inclined surface 83Yd2 may be directly connected.

### Joining Surface

As illustrated in FIG. 10D, the first flange portion 430Ya3 of the first frame 430Ya has a first joining surface 431, a second joining surface 432, a third joining surface 433, and a fourth joining surface 434. The second flange portion 430Yb3 of the second frame 430Yb has a first joining surface 441, a second joining surface 442, a third joining surface 443, and a fourth joining surface 445. The outer edge portion 83Ya of the filter 83Y has a first edge portion 451, a second edge portion 452, a third edge portion 453, and a fourth edge portion 454.

The first joining surface 431 and the second joining surface 432 of the first flange portion 430Ya3 are each formed in a planar shape extending in the X1 direction. The first joining surface 431 and the second joining surface 432 are formed continuously with the third joining surface 433 and the fourth joining surface 434, respectively. The first joining surface 431 is provided at the left end side of the first flange portion 430Ya3, and the second joining surface 432 is provided at the right end side of the flange portion 430Ya3. The third joining surface 433 is provided at the front end side of the first flange portion 430Ya3, and the fourth joining surface 434 is provided at the rear end side of the first flange portion 430Ya3. Since the third joining surface 433 and the fourth joining surface 434 are similarly configured, the third joining surface 433 will be mainly described.

The third joining surface 433 has a first inclined surface 433a as an inclined surface that slopes downward as it proceeds downstream in the Y1 direction, a second inclined surface 433b that slopes downward as it proceeds upstream in the Y1 direction, and an intermediate surface 433c. When viewed in the X1 direction, the first inclined surface 433a slopes downward in the gravitational direction G toward the lowest portion 83Yb as it approaches the lowest portion 83Yb in the Y1 direction. When viewed in the X1 direction, the second inclined surface 433b is arranged opposite to the first inclined surface 433a with respect to the lowest portion 83Yb in the Y1 direction, and slopes downward in the gravitational direction G toward the lowest portion 83Yb as it approaches the lowest portion 83Yb. When viewed in the X1 direction, the intermediate surface 433c is provided between the first inclined surface 433a and the second inclined surface 433b in the Y1 direction, and is curved so as to smoothly connect the first inclined surface 433a and the second inclined surface 433b.

Alternatively, the intermediate surface 433c may be omitted and the first inclined surface 433a and the second inclined surface 433b may be directly connected, or the intermediate surface 433c may be formed as a flat surface. Furthermore, not limited to the entirety of the first inclined surface 433a, a portion of the first inclined surface 433a may constitute an inclined surface or a clamping surface.

The first joining surface 441 and the second joining surface 442 of the second flange portion 430Yb3 are each formed as a flat surface extending in the X1 direction. The first joining surface 441 is provided at the left end side of the second flange portion 430Yb3, and the second joining surface 442 is provided at the right end side of the second flange portion 430Yb3. The third joining surface 443 is provided at the front end side of the second flange portion 430Yb3, and the fourth joining surface 445 is provided at the rear end side of the second flange portion 430Yb3. Since the third joining surface 443 and the fourth joining surface 445 are similarly configured, the third joining surface 443 will be mainly described.

The third joining surface 443 has a first inclined surface 443a, a second inclined surface 443b, and an intermediate surface 443c. The first inclined surface 443a is a clamping surface inclined downward toward the downstream in the Y1 direction and an inclined surface as a first clamping surface. The second inclined surface 443b is an inclined surface as a second clamping surface inclined downward toward the upstream side in the Y1 direction. The intermediate surface 443c is an inclined surface as an intermediate clamping surface. The first inclined surface 443a, the second inclined surface 443b, and the intermediate surface 443c are respectively opposed to the first inclined surface 433a, the second inclined surface 433b, and the intermediate surface 433c in the gravitational direction G. In other words, the first inclined surface 443a, the second inclined surface 443b, and the intermediate surface 443c are respectively arranged at positions overlapping the first inclined surface 433a, the second inclined surface 433b, and the intermediate surface 433c in the gravitational direction G. The intermediate surface 443c is provided, when viewed in the X1 direction, between the first inclined surface 443a and the second inclined surface 443b in the Y1 direction, and is curved so as to smoothly connect the first inclined surface 443a and the second inclined surface 443b. The first inclined surface 443a and the second inclined surface 443b are inclined downward toward the lowest portion 83Yb of the filter 83Y in the Y1 direction along the first inclined surface 433a and the second inclined surface 433b when viewed in the X1 direction. Alternatively, the intermediate surface 443c may be omitted and the first inclined surface 443a and the second inclined surface 443b may be directly connected, or the intermediate surface 443c may be formed as a flat surface. Furthermore, not limited to the entirety of the entirety of the first inclined surface 443a, a portion of the first inclined surface 443a may constitute a clamping surface or an inclined surface.

The first edge portion 451 and the second edge portion 452 of the outer edge portion 83Ya of the filter 83Y are each formed as a flat surface extending in the X1 direction. The first edge portion 451 is provided at the left end side of the outer edge portion 83Ya, and the second edge portion 452 is provided at the right end side of the outer edge portion 83Ya. The third edge portion 453 is provided at the front end side of the outer edge portion 83Ya, and the fourth edge portion 454 is provided at the rear end side of the outer edge portion 83Ya. Since the third edge portion 453 and the fourth edge portion 454 are similarly configured, the third edge portion 453 will be mainly described.

The third joining surface 443 has a first inclined surface 443a, a second inclined surface 443b, and an intermediate surface 443c. The first inclined surface 443a is a clamping surface inclined downward toward the downstream in the Y1 direction and an inclined surface as a first clamping surface. The second inclined surface 443b is an inclined surface as a second clamping surface inclined downward toward the upstream side in the Y1 direction. The intermediate surface 443c is an inclined surface as an intermediate clamping surface. The first inclined surface 443a, the second inclined surface 443b, and the intermediate surface 443c are respectively opposed to the first inclined surface 433a, the second inclined surface 433b, and the intermediate surface 433c in the gravitational direction G. In other words, the first inclined surface 443a, the second inclined surface 443b, and the intermediate surface 443c are respectively arranged at positions overlapping the first inclined surface 433a, the second inclined surface 433b, and the intermediate surface 433c in the gravitational direction G. The intermediate surface 443c is provided, when viewed in the X1 direction, between the first inclined surface 443a and the second inclined surface 443b in the Y1 direction, and is curved so as to smoothly connect the first inclined surface 443a and the second inclined surface 443b. The first inclined surface 443a and the second inclined surface 443b are inclined downward toward the lowest portion 83Yb of the filter 83Y in the Y1 direction along the first inclined surface 433a and the second inclined surface 433b when viewed in the X1 direction. Alternatively, the intermediate surface 443c may be omitted and the first inclined surface 443a and the second inclined surface 443b may be directly connected, or the intermediate surface 443c may be formed as a flat surface. Furthermore, not limited to the entirety of the entirety of the first inclined surface 443a, a portion of the first inclined surface 443a may constitute a clamping surface or an inclined surface.

The first edge portion 451 and the second edge portion 452 of the outer edge portion 83Ya of the filter 83Y are each formed as a flat surface extending in the X1 direction. The first edge portion 451 is provided at the left end side of the outer edge portion 83Ya, and the second edge portion 452 is provided at the right end side of the outer edge portion 83Ya. The third edge portion 453 is provided at the front end side of the outer edge portion 83Ya, and the fourth edge portion 454 is provided at the rear end side of the outer edge portion 83Ya. Since the third edge portion 453 and the fourth edge portion 454 are similarly configured, the third edge portion 453 will be mainly described.

The first joining surfaces 431 and 441, the second joining surfaces 432 and 442, the third joining surfaces 433 and 443, and the fourth joining surfaces 434 and 445 are ultrasonically welded to each other, whereby the first flange portion 430Ya3 and the second flange portion 430Yb3 are joined. At this time, the third joining surfaces 433 and 443 and the fourth joining surfaces 434 and 445 are disposed so as to overlap the bottom surface portion 83Yd of the filter 83Y as viewed in the short side direction (X1 direction). Note that the first flange portion 430Ya3 and the second flange portion 430Yb3 may be fixed together not only by ultrasonic welding but also by heat welding, adhesives such as double-sided tape or hot melt, or screws or the like.

By joining the first flange portion 430Ya3 and the second flange portion 430Yb3, the filter 83Y sandwiched between the first flange portion 430Ya3 and the second flange portion 430Yb3 is held in place. If the holding force for the filter 83Y is insufficient, the entire circumference of the outer edge portion 83Ya of the filter 83Y may be adhered to at least one of the first flange portion 430Ya3 and the second flange portion 430Yb3. As a result, the filter 83Y can be held with a high holding force.

Furthermore, since the filter 83Y is clamped between the first flange portion 430Ya3 and the second flange portion 430Yb3, the filter 83Y is held in a posture along the respective joining surfaces of the first flange portion 430Ya3 and the second flange portion 430Yb3. In particular, since the third edge portion 453 of the filter 83Y is clamped by the third joining surfaces 433 and 443, which are formed in a substantially V-shape, and the fourth edge portion 454 of the filter 83Y is clamped by the fourth joining surfaces 434 and 445, which are also formed in a substantially V-shape, the filter 83Y is held in a substantially V-shaped posture with the lowest portion 83Yb as the lowermost point.

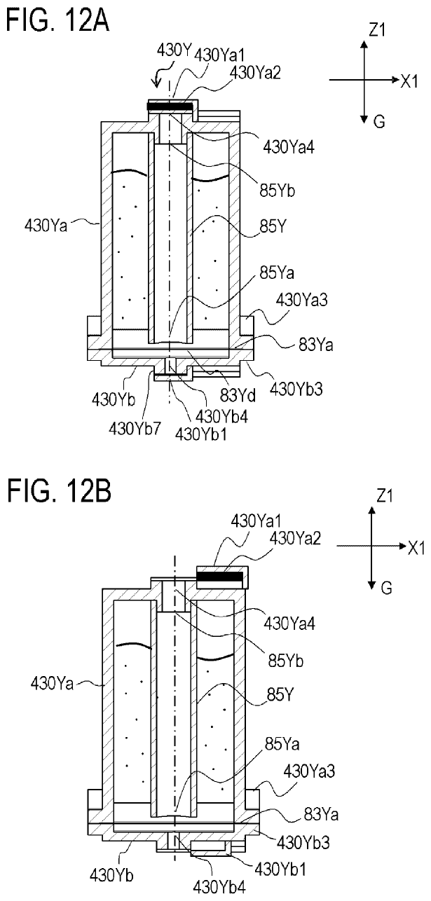

The lowest portion 83Yb of the filter 83Y extends in the short side direction (X1 direction), and the bottom surface portion 83Yd of the filter 83Y extends parallel to the short side direction (X1 direction) over the entire area in the short side direction (X1 direction). In other words, in a predetermined cross-section perpendicular to the long side direction (Y1 direction), the bottom surface portion 83Yd is at an equal distance from the outlet 85Yb in the gravitational direction G or the Z1 direction over the entire area in the short side direction (X1 direction). That is, as illustrated in FIG. 12A, in the X1Z1 plane, the distance GD in the Z1 direction between the discharge port 430Ya4 and the bottom surface portion 83Yd is equal over the entire area in the short side direction (X1 direction). Additionally, the first joining surface 441 is opposed to the first joining surface 431 in the gravitational direction G. In other words, the first joining surface 441 is arranged at a position overlapping the first joining surface 431 in the gravitational direction G.

That is, the filter 83Y is formed by folding a single rectangular sheet at the lowest portion 83Yb, and does not have a complex three-dimensional shape with unevenness. Therefore, the filter 83Y can be formed from a sheet-like nonwoven fabric made of resin fibers, for example, and does not need to be three-dimensionally shaped by heat pressing or the like. In other words, when the outer edge portion 83Ya of the filter 83Y is not clamped between the first frame 430Ya and the second frame 430Yb, the filter 83Y is a flat sheet. Thus, it is possible to configure the filter 83Y at low cost while holding the filter 83Y in a substantially V-shaped posture. Compared to a molded component formed by heat pressing or the like, the sheet-like filter 83Y can be made thinner, which increases the toner capacity of the toner cartridge 430Y.

Normally, in order to move the toner along the slope only by its own weight, it is necessary to set the inclination angle θ of the slope with respect to the horizontal plane to about 70 degrees. However, in the present embodiment, since the toner placed on the filter 83Y in the toner storage chamber 430Yc is fluidized by air, the inclination angle of the slope of the filter 83Y with respect to the horizontal plane may be set to about 10 to 20 degrees as illustrated in FIG. 10A. As a result, the capacity of the toner cartridge 430Y can be increased and the amount of toner to be stored in the toner cartridge 430Y can be increased.

In the present embodiment, both the first frame 430Ya and the second frame 430Yb are provided with the third joining surfaces 433 and 443, which contact the third edge portion 453 of the outer edge portion 83Ya of the filter 83Y and are inclined relative to the long side direction (Y1 direction) and the gravitational direction G, but the configuration is not limited thereto. That is, at least one of the first frame 430Ya and the second frame 430Yb may be provided with the third joining surface 433, and at least the other of the first frame 430Ya and the second frame 430Yb may be provided with a clamping surface for clamping the third edge portion 453 together with the third joining surface 433. For example, only the first frame 430Ya, among the first frame 430Ya and the second frame 430Yb, may be provided with the third joining surface 433, which contacts the third edge portion 453 and is inclined relative to the long side direction (Y1 direction) and the gravitational direction G. In this case, the third joining surface 443 of the second frame 430Yb as the clamping surface may be formed parallel to the Y1Z1 plane, and a scaling member (not shown) may be provided between the third joining surface 433 and the third joining surface 443.

### Discharge Pipe

As illustrated in FIGS. 10A to 10C, a discharge pipe 85Y is disposed inside the toner storage chamber 430Yc. The discharge pipe 85Y has an inlet 85Ya that opens downward in the gravitational direction G, and an outlet 85Yb as a second pipe opening that opens upward, that is, downstream in the Z1 direction, communicates with the discharge port 430Ya4 of the toner cartridge 430Y, and communicates with the outside of the toner cartridge 430Y. The outlet 85Yb is positioned linearly above the inlet 85Ya. Since the discharge pipe 85Y has no bent portion or the like in the middle, a pressure loss during conveyance can be minimized.

The inlet 85Ya is arranged near the central portion of the container in the X1 direction as illustrated in FIGS. 12A and 12B. In the X1 direction, no slope is provided to the filter 83Y, and thus the effect of conveying the toner is weak. By disposing near the central portion, distances from both ends in the X1 direction to the inlet 85Ya become equal, and as compared with a configuration in which the inlet 85Ya is disposed at one end and the distance to the other end increases, the amount of toner remaining without being supplied in the toner storage chamber 430Yc can be reduced. In the present embodiment, the discharge pipe 85Y is made of a resin material, but it may also be made of paper, rubber, or the like. In the present embodiment, the discharge pipe 85Y is configured as a separate member from the first frame 430Ya, but as described above, since the discharge pipe 85Y does not have a bent portion or the like in the middle, it can be configured integrally with the first frame 430Ya.

As illustrated in FIG. 10A, the inlet 85Ya is disposed with a gap in the lowest portion 83Yb as an opposing region of the filter 83Y. This gap serves as a toner inflow port.

As described above, the filter 83Y is held in a substantially V-shaped posture with the lowest portion 83Yb as the lowermost point, and when the remaining amount of toner in the toner storage chamber 430Yc decreases, the toner fluidized by air moves along the slope of the filter 83Y and gathers at the lowest portion 83Yb. That is, the toner in the toner storage chamber 430Yc can be guided toward the inlet 85Ya of the discharge pipe 85Y. Moreover, the bottom surface portion 83Yd of the filter 83Y extends in parallel to the short side direction (X1 direction), and is inclined only in the long side direction (Y1 direction). Therefore, while keeping the filter 83Y simple, the toner can be efficiently collected at the lowest portion 83Yb of the filter 83Y. Therefore, even when the remaining amount of the toner in the toner storage chamber 430Yc decreases, the toner collected in the lowest portion 83Yb can be efficiently discharged from the inlet 85Ya of the discharge pipe 85Y to the outside of the toner cartridge 430Y via the discharge port 430Ya4.

### Shutter of Toner Cartridge

A shutter configuration provided in the toner cartridge will be described with reference to FIGS. 10A to 10D and FIGS. 12A and 12B.

As illustrated in FIG. 10A, a discharge port cover 430Ya1 and a discharge port seal 430Ya2 are provided on the upper surface of the first frame 430Ya so as to cover the opening of the discharge port 430Ya4 slidably provided in the X1 direction. As illustrated in FIG. 10D, the discharge port seal 430Ya2 is a rectangular flexible sealing member, and is held by means such as double-sided tape bonding (not illustrated) with respect to the discharge port cover 430Ya1. The discharge port cover 430Ya1 and the discharge port seal 430Ya2 can prevent the toner inside the toner cartridge 430Y from leaking to the outside.

An intake port cover 430Yb1 is provided so as to cover an opening of an intake port 430Yb4 provided on the bottom surface of the second frame 430Yb to be slidable in the X1 direction. This intake port cover 430Yb1 can prevent problems such as mixing of foreign matter into the opening.

FIGS. 12A and 12B show a cross section taken along line 12A-12A of FIG. 9E, respectively. FIG. 12A is a diagram of a state in which an air intake port and a toner discharge port are covered with a cover. FIG. 12B is a diagram illustrating a state in which the cover is retracted and the air inlet and the toner outlet are exposed.

As illustrated in FIG. 12B, by moving the discharge port cover 430Ya1 and the intake port cover 430Yb1 holding the discharge port seal 430Ya2 in the X1 direction, both covers can be retracted to the positions where the discharge port 430Ya4 and the intake port 430Yb4 are exposed.

Shutter Opening/Closing accompanying Mounting/Demounting of Toner Cartridge

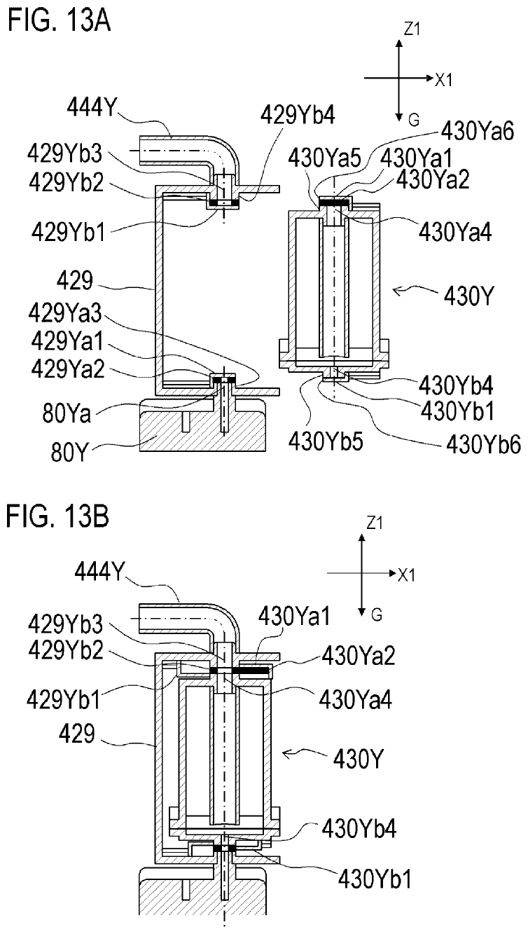

A shutter opening and closing operation accompanying mounting and demounting of the toner cartridge to and from the apparatus main body will be described with reference to FIGS. 13A and 13B. FIGS. 13A and 13B are partial sectional views taken along line 13A-13A in FIG. 5B. FIG. 13A illustrates a cross-sectional view in a state where the toner cartridge is removed from the cartridge holder. FIG. 13B illustrates a cross-sectional view in a state where the toner cartridge is mounted to the cartridge holder.

As illustrated in FIG. 13A, in a state where the toner cartridge 430Y is detached from the cartridge holder 429, the discharge port 430Ya4 is covered with the discharge port cover 430Ya1 and the discharge port seal 430Ya2. The intake port 430Yb4 is covered with an intake port cover 430Yb1. The discharge port 80Ya as a feeding port of the pump unit 80Y is covered with an air discharge port cover 429Ya1 and an air discharge port seal 429Ya2 as feeding port covers held slidably in the X1 direction. The holder discharge port 429Yb3 as a receiving port of the cartridge holder 429 is covered with a holder discharge port cover 429Yb1 as a receiving port cover slidably held in the X1 direction and a holder discharge port seal 429Yb2. The air discharge port seal 429Ya2 and the holder discharge port seal 429Yb2 are made of flexible members such as sponge or elastomer, and have cylindrical through holes.

From this state, a state in which the toner cartridge 430Y is mounted to the cartridge holder 429 is illustrated in FIG. 13B.

When the toner cartridge 430Y is mounted while being slid in the −X1 direction, the holder discharge port cover 429Yb1 is slid by the discharge-port pressing portion 430Ya5 of the first frame 430Ya. By the pressing of the discharge-port pressing portion 430Ya5 as the receiving-port cover pressing portion (first cartridge pressing portion), the holder discharge port cover 429Yb1 moves from the receiving-port closing position where the holder discharge port 429Yb3 is covered to the receiving-port opening position where the holder discharge port 429Yb3 is exposed. The discharge-port pressing portion 430Ya5 is provided adjacent to the end surface of the toner cartridge 430Y in which the discharge port 430Ya4 is opened in the Z1 direction. Further, the holder-discharge-port pressing portion 429Yb4 and the air discharge port seal 429Ya2 (first body pressing portion) of the cartridge holder 429 press the discharge-port cover pressed portion 430Ya6 (first pressed portion) to slide the discharge port cover 430Ya1 and the discharge port seal 430Ya2 of the first frame 430Ya. At the time of sliding, since the discharge port seal 430Ya2 moves in the −X1 direction without a gap with respect to the holder discharge port seal 429Yb2, it is possible to prevent the toner in the conveyance passage from leaking to the outside. The sliding direction of the holder discharge port cover 429Yb1 and the discharge port cover 430Ya1 is substantially parallel to the mounting/demounting direction of the toner cartridge 430Y with respect to the cartridge holder 429.

Similarly, when the toner cartridge 430Y is mounted while being slid in the −X1 direction, the air discharge port cover 429Ya1 is slid by an intake-port pressing portion 430Yb5 of the second frame 430Yb. By the pressing of the intake-port pressing portion 430Yb5 as a feeding-port cover pressing portion (second cartridge pressing portion), the air discharge port cover 429Ya1 moves from the feeding-port closing position where the air discharge port 80Ya as a feeding port is covered to the feeding-port opening position where the air discharge port 80Ya is exposed. The intake-port pressing portion 430Yb5 is provided adjacent to the end surface of the toner cartridge 430Y in which the intake 430Yb4 is opened in the Z1 direction. The intake port 430Yb4 is provided on a protruding portion 430Yb7 protruding in the Z1 direction from the surface of the second frame 430Yb of the toner cartridge 430Y. Further, the intake-port cover pressed portion 430Yb6 (second pressed portion) is pressed by the air-discharge-port pressing portion 429Ya3 and the air discharge port seal 429Ya2 (second body pressing portion) of the cartridge holder 429 to slide the intake port cover 430Yb1 of the second frame 430Yb. The sliding direction of the air discharge port cover 429Ya1 and the intake port cover 430Yb1 is substantially parallel to the mounting/demounting direction of the toner cartridge 430Y with respect to the cartridge holder 429.

When the mounting of the toner cartridge 430Y is completed, the discharge port 430Ya4 of the toner cartridge 430Y and the holder discharge port 429Yb3 (receiving port) of the cartridge holder 429 communicate with each other. In addition, the intake port 430Yb4 of the toner cartridge 430Y and the air discharge port 80Ya of the pump unit 80Y communicate with each other. As a result, air can be supplied to the inside of the toner cartridge 430Y by the pump unit 80Y, and toner can be supplied from the inside of the toner cartridge 430Y to the developer container 3Y via the supply pipe 444Y.

### Other Embodiments

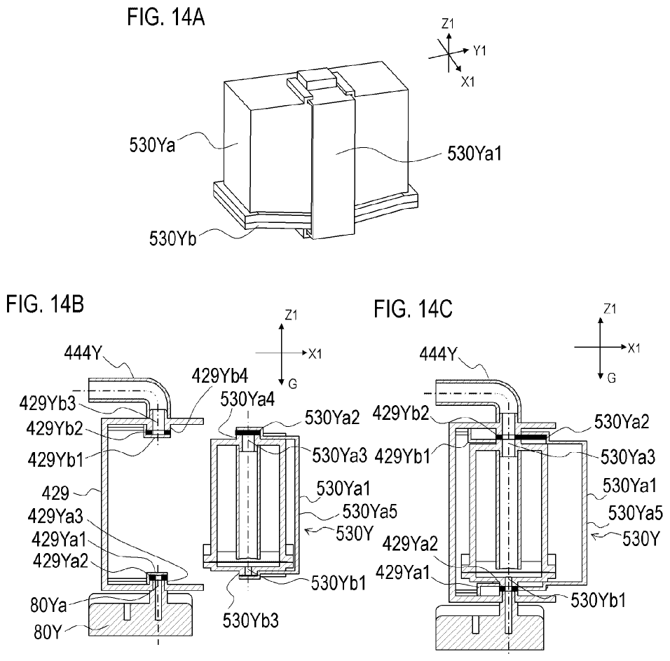

In the first embodiment, the configuration in which the cover of the air intake port of the toner cartridge and the cover of the toner discharge port are provided as separate members and can be mounted and demounted independently of each other has been described. However, as illustrated in FIGS. 14A to 14C, both may be integrally configured.

FIG. 14A is a perspective view of a configuration integrally including a cover for an air intake port of the toner cartridge and a cover for a toner discharge port. FIGS. 14B and 14C are partial cross-sectional views of a portion corresponding to a cross section taken along line 13A-13A of FIG. 5B. FIG. 14B illustrates a cross-sectional view in a state where the toner cartridge is removed from the cartridge holder. FIG. 14C illustrates a cross-sectional view in a state where the toner cartridge is mounted to the cartridge holder.

As illustrated in FIG. 14B, the upper surface of the toner cartridge 530Y is provided with a discharge port 530Ya3 as a container opening including a through port penetrating in the Z1 direction, through which the toner in the toner storage chamber 530Yc is discharged to the outside of the toner cartridge 530Y. In addition, the bottom surface of the toner cartridge 530Y is provided with an intake port 530Yb1 as a container opening including a through port penetrating in the Z1 direction.

An intake/discharge-integrated cover 530Ya1 slidably held in the X1 direction is provided across the upper surface and the bottom surface so as to cover the discharge port 530Ya3 and the intake port 530Yb1. In the intake/discharge-integrated cover 530Ya1, a discharge-port cover portion (first cover portion) that closes the discharge port 530Ya3 and an intake port cover portion (second cover portion) that closes the intake port 530Yb1 are connected by a connecting portion 530Ya5. The connecting portion 530Ya5 is provided at the downstream end of the toner cartridge 530Y in the direction in which the intake/discharge-integrated cover 530Ya1 moves from the closed position to the open position in the X1 direction. The position where the connecting portion 530Ya5 is provided is also a downstream end in the detachment direction from the cartridge holder 529 of the toner cartridge 530Y. A discharge port seal 530Ya2 is provided between the discharge port 530Ya3 and the intake/discharge-integrated cover 530Ya1. The discharge port seal 530Ya2 is a rectangular flexible sealing member, and is held by means such as double-sided tape bonding (not illustrated) with respect to the intake/discharge-integrated cover 530Ya1. Due to the intake/discharge-integrated cover 530Ya1 and the discharge port seal 530Ya2, it is possible to prevent the inside toner from leaking to the outside in a state where the toner cartridge 530Y is detached from the apparatus main body.

From this state, a state in which the toner cartridge 530Y is mounted to the cartridge holder 529 is illustrated in FIG. 14C.

When the toner cartridge 530Y is mounted while being slid in the −X1 direction, the holder discharge port cover 429Yb1 is slid by a discharge-port pressing portion 530Ya4 of the first frame 530Ya. In addition, the discharge port cover 530Ya1 and the discharge port seal 430Ya2 of the first frame 530Ya are slid by the holder-discharge-port pressing portion 429Yb4 of the cartridge holder 429. At the time of sliding, since the discharge port seal 430Ya2 moves in the −X1 direction without a gap with respect to the holder discharge port seal 429Yb2, it is possible to prevent the toner in the conveyance passage from leaking to the outside.

Similarly, when the toner cartridge 430Y is mounted while being slid in the −X1 direction, the air discharge port cover 429Ya1 is slid by the intake-port pressing portion 530Yb3 of the second frame 530Yb. Further, the intake port cover 430Yb1 of the second frame 430Yb is slid by the air-discharge-port pressing portion 429Ya3 of the cartridge holder 429.

When the mounting of the toner cartridge 530Y is completed, the discharge port 530Ya3 of the toner cartridge 530Y and the holder discharge port 429Yb3 of the cartridge holder 429 communicate with each other. In addition, the intake port 530Yb4 of the toner cartridge 530Y and the air discharge port 80Ya of the pump unit 80Y communicate with each other. As a result, air can be supplied to the inside of the toner cartridge 530Y by the pump unit 80Y, and toner can be supplied from the inside of the toner cartridge 530Y to the developer container 3Y via the supply pipe 444Y.

In the present embodiment, the configuration in which the intake port cover of the toner cartridge is slidable in the X1 direction and held by the toner cartridge has been described, but the intake port cover may be detachably provided with respect to the toner cartridge.

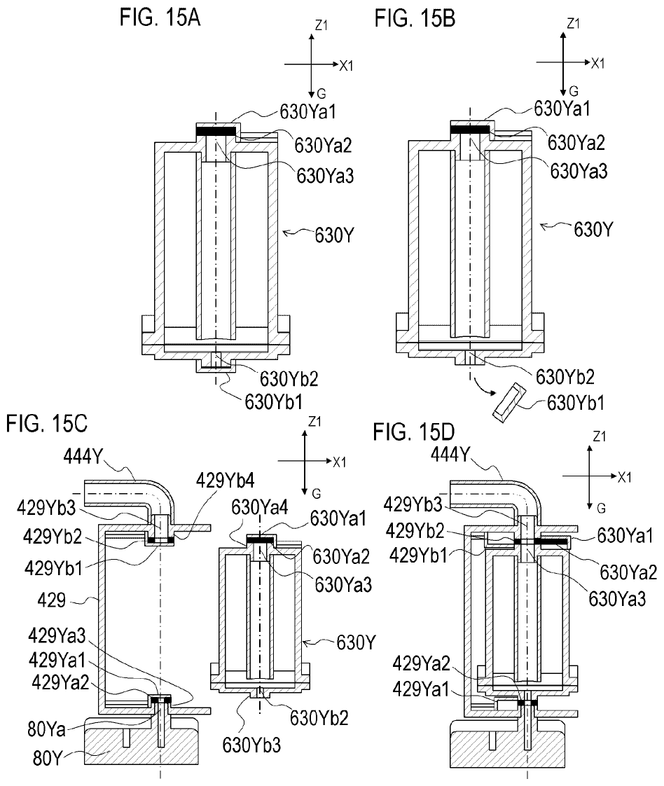

FIGS. 15A to 15D are partial cross-sectional views of a portion corresponding to a cross section taken along line 13A-13A of FIG. 5B. FIG. 15A illustrates a cross-sectional view illustrating a state in which the intake port cover is mounted to the toner cartridge. FIG. 15B illustrates a cross-sectional view of a state in which the intake port cover is removed from the toner cartridge. FIG. 15C illustrates a cross-sectional view of a state in which the toner cartridge with the intake port cover removed is removed from the cartridge holder. FIG. 15D illustrates a cross-sectional view in a state where the toner cartridge is mounted to the cartridge holder.

As illustrated in FIG. 15A, an intake port cover 630Yb1 is provided so as to cover an intake port 630Yb2 that takes in the air of the toner cartridge 630Y. The holding method may be indentation, bonding, or the like in addition to screwing, but is not slidably held as in the first embodiment.

As illustrated in FIG. 15B, the intake port cover 630Yb1 can be removed from the intake port 630Yb2.

Although it is effective to cover the intake port 630Yb2 with the intake port cover 630Yb1 in order to avoid the above-described foreign matter mixing risk and the like, since the intake port is an air supply passage, even if the toner cartridge 630Y is exposed in a state of being detached from the apparatus main body, problems such as toner leakage do not occur.

With the intake port cover 630Yb1 removed, the toner cartridge 630Y can be slid and mounted to the cartridge holder 429 as illustrated in FIGS. 15C and 15D. At this time, if the toner cartridge 630 is to be mounted to the cartridge holder 429 while the intake port cover 630Yb1 is erroneously mounted, the intake port cover 630Yb1 interferes with the cartridge holder 429 in the Z1 direction and the mounting is not possible. That is, the toner cartridge 630Y is configured not able to be mounted to the cartridge holder 429 in a state where the intake port cover 630Yb1 is not detached from the intake port 630Yb2. As a result, a problem that the function of air supply is impaired due to erroneous mounting does not occur.

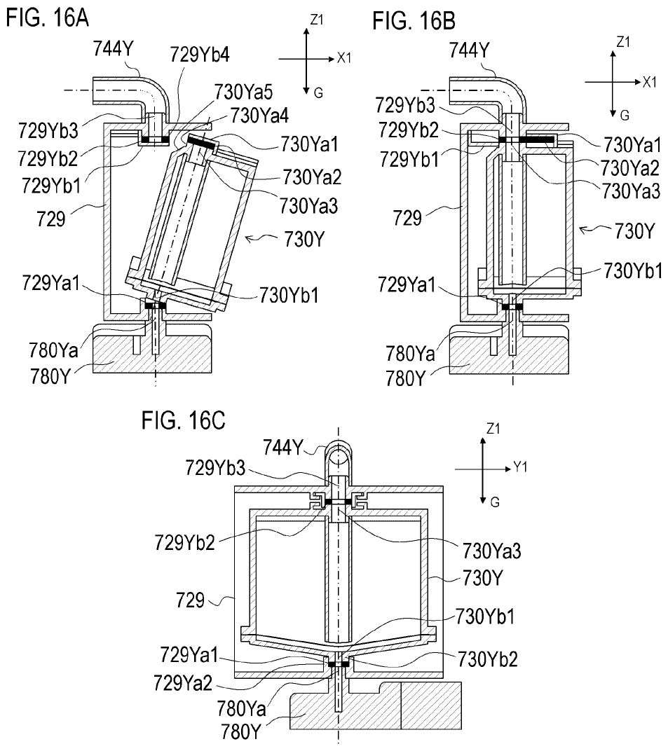

In the above-described embodiment, the configuration in which the toner cartridge is slid and mounted to the cartridge holder has been described, but the toner cartridge may be mounted by a rotation operation as illustrated in FIGS. 16A to 16C.

FIGS. 16A and 16B are partial cross-sectional views of a portion corresponding to a cross section taken along line 13A-13A of FIG. 5B. FIG. 16A illustrates a cross-sectional view illustrating a state in which the toner cartridge starts to be mounted to the cartridge holder. FIG. 16B illustrates a cross-sectional view of a state in which the toner cartridge is completely mounted to the cartridge holder. FIG. 16C is a partial cross-sectional view taken along line 16A-16A in FIG. 5B, and illustrates a cross-sectional view in a state where the toner cartridge is completely mounted to the cartridge holder.

In this configuration, when a toner cartridge 730Y is mounted to a cartridge holder 729, the mounting operation is performed in a state where the cover is not mounted to an intake port 730Yb1 of the toner cartridge 730Y.

As illustrated in FIG. 16A, first, the intake port 730Yb1 of the toner cartridge 730Y is brought into contact with an air discharge port seal 729Ya1 of the cartridge holder 729, and the toner cartridge 730Y is rotated with this portion as a fulcrum. As illustrated in FIG. 16C, the intake port 730Yb1 of the toner cartridge 730Y serving as a turning fulcrum has a protruding positioning portion 730Yb2, and is engaged with a recessed positioned portion 729Ya2 of the cartridge holder 729 to be positioned in the X1 direction and the Y1 direction. Then, a discharge port cover 730Ya1 on the upper surface of the toner cartridge 730Y, a discharge port seal 730Ya2, and a holder discharge port cover 729Yb1 of the cartridge holder 729 are moved by the rotation operation. As illustrated in FIGS. 16B and 16C, in a state where the mounting of the toner cartridge 730Y is completed, an air discharge port 780Ya and the intake port 730Yb1, and a discharge port 730Ya3 and a holder discharge port 729Yb3 communicate with each other. Since the shutter opening/closing of the discharge port portion is performed by the rotation operation, the opening/closing locus is desirably rotated rather than the linear movement. However, in a state where the mounting is completed, the coordinates of the intake port 730Yb1 and the discharge port 730Ya3 in the X1 direction substantially coincide with each other. That is, the intake port 730Yb1 and the discharge port 730Ya3 overlap in the gravitational direction. Therefore, the discharge port 730Ya3 of the toner cartridge 730Y and the holder discharge port 729Yb3 of the cartridge holder 729 are in contact with each other, and the direction of the force generated when the discharge port cover 730Ya1, the discharge port seal 730Ya2, and the holder discharge port cover 729Yb1 move substantially coincides with the moving direction, and even the linear shutter can operate smoothly. In addition, an area where component interference occurs on the rotation locus of the toner cartridge 730 and the cartridge holder 729 at the time of mounting needs to have a retracted shape such as 730Ya5, and the retracted area leads to a decrease in the toner capacity. In order to minimize the retraction amount, it is desirable to arrange the intake port 730Yb1 and the discharge port 730Ya3 as close as possible in the −X1 direction of the toner cartridge 730Y.

The configurations of the respective embodiments described above can be combined with each other as much as possible.

According to the present disclosure, it is possible to provide an embodiment of a cartridge that stores toner and an image forming apparatus including the cartridge.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159514, filed on Sep. 13, 2024, which is hereby incorporated by reference herein in its entirety.

What is claimed is:

1. A cartridge comprising:
a developer storage chamber that stores developer and is provided with a discharge port for discharging the stored developer to outside of the cartridge;
a filter that allows air to pass therethrough and prevents developer from passing therethrough;
an air chamber that is partitioned from the developer storage chamber by the filter and is provided with an intake port for taking in air from the outside, the air chamber being aligned with the developer storage chamber in a first direction;
a first cover portion configured to be movable between a closed position where the discharge port is closed by the first cover portion and an open position where the discharge port is opened by the first cover portion; and
a second cover portion that closes the intake port.

2. The cartridge according to claim 1,
wherein in a case where the open position and the closed position are a first open position and a first closed position, respectively, the second cover portion is configured to be movable, independently of the first cover portion, between a second closed position where the intake port is closed and a second open position where the intake port is opened.

3. The cartridge according to claim 2,
wherein the discharge port is provided on one end surface of the cartridge in the first direction,
wherein the intake port is provided on another end surface of the cartridge in the first direction, and
wherein a direction in which the first cover portion moves between the first open position and the first closed position and a direction in which the second cover portion moves between the second open position and the second closed position are a second directions intersecting with the first direction.

4. The cartridge according to claim 3,
wherein the cartridge is configured to be attachable to and detachable from an apparatus main body of an image forming apparatus in the second direction.

5. The cartridge according to claim 1,
wherein the second cover portion is integrally formed with the first cover portion, the second cover portion closing the intake port in a case where the first cover portion is at the closed position, and opening the intake port in a case where the first cover portion is at the open position.

6. The cartridge according to claim 5,
wherein the discharge port is provided on one end surface of the cartridge in the first direction,
wherein the intake port is provided on another end surface of the cartridge in the first direction, and
wherein a direction in which the first cover portion and the second cover portion move between the open position and the closed position is a second direction intersecting the first direction, and
wherein a connecting portion connecting the first cover portion and the second cover portion is provided at a downstream end of the cartridge in a direction from the closed position to the open position in the second direction.

7. The cartridge according to claim 6,
wherein the cartridge is configured to be attachable to and detachable from an apparatus main body of an image forming apparatus in the second direction, and
wherein the connecting portion is provided at a downstream end of the cartridge in a detachment direction from the apparatus main body.

8. The cartridge according to claim 1, comprising a frame that constitutes the air chamber and is provided with the intake port,
wherein the second cover portion is configured to be detachable from the frame.

9. The cartridge according to claim 8,
wherein the cartridge is configured to be attachable to an apparatus main body of the image forming apparatus in a state where the second cover portion is detached from the frame, and not to be attachable to the apparatus main body in a state where the second cover portion is not detached from the frame.

10. The cartridge according to claim 1, comprising a frame that constitutes the developer storage chamber and is provided with the discharge port,
wherein the first cover portion is supported by the frame so as to be movable with respect to the frame between the closed position and the open position.

11. The cartridge according to claim 4,
wherein the cartridge is configured to be attachable to and detachable from the apparatus main body of the image forming apparatus, the apparatus main body including a first body pressing portion, and
wherein the first cover portion includes a first pressed portion, the first pressed portion being configured to be moved from the first closed position to the first open position by being pressed by the first body pressing portion in a case where the cartridge is attached to the apparatus main body.

12. The cartridge according to claim 11,
wherein the apparatus main body includes a second body pressing portion, and
wherein the second cover portion includes a second pressed portion, the second pressed portion being configured to be moved from the second closed position to the second open position by being pressed by the second body pressing portion in a case where the cartridge is attached to the apparatus main body.

13. The cartridge according to claim 1,
wherein the cartridge is configured to be attachable to and detachable from an apparatus main body of an image forming apparatus, the apparatus main body including a receiving port for receiving developer discharged from the discharge port of the cartridge in a state where the cartridge is attached, and a receiving port cover movable between a receiving-port closing position where the receiving port is closed and a receiving-port opening position where the receiving port is opened, and
wherein the cartridge comprises a first cartridge pressing portion, the first cartridge pressing portion pressing the receiving port cover so as to move the receiving port cover from the receiving-port closing position to the receiving-port opening position in a case where the cartridge is attached to the apparatus main body.

14. The cartridge according to claim 13,
wherein the first cartridge pressing portion is provided adjacent to an end surface of the cartridge in which the discharge port is opened in the first direction.

15. The cartridge according to claim 13,
wherein the apparatus main body is configured to be communicable with the intake port in a state where the cartridge is attached, the apparatus main body including a feeding port that supplies air through the intake port, and a feeding port cover movable between a feeding-port closing position where the feeding port is closed and a feeding-port opening position where the feeding port is opened, and
wherein the cartridge comprises a second cartridge pressing portion, the second cartridge pressing portion pressing the feeding port cover so as to move the feeding port cover from the feeding-port closing position to the feeding-port opening position in a case where the cartridge is attached to the apparatus main body.

16. The cartridge according to claim 15,
wherein the second cartridge pressing portion is provided adjacent to an end surface of the cartridge in which the intake port is opened in the first direction.

17. The cartridge according to claim 1,
wherein the intake port is provided on a protruding portion that protrudes in the first direction from a surface of a frame constituting the air chamber.

18. The cartridge according to claim 1,
wherein the cartridge is configured to be attachable to and detachable from an apparatus main body of an image forming apparatus, and
wherein in a state where the cartridge is attached in the apparatus main body,
the first direction is a gravitational direction, and
wherein the air chamber is positioned below the developer storage chamber.

19. The cartridge according to claim 18,
wherein the discharge port and the intake port have a region overlapping each other in a case of being viewed in the first direction.

20. A cartridge comprising:
a developer storage chamber that stores developer and is provided with a discharge port for discharging the stored developer to outside of the cartridge;
a filter that allows air to pass therethrough and prevents developer from passing therethrough;
an air chamber that is partitioned from the developer storage chamber by the filter and is provided with an intake port for taking in air from the outside, the air chamber being aligned with the developer storage chamber in a first direction; and
a first cover portion that is configured to be movable between a first closed position where the discharge port is closed and a first open position where the discharge port is opened.
